(19) United States
(12) Patent Application Publication
(10) Pub. No.: US 2024/0354176 A1
(43) Pub. Date: Oct. 24, 2024

(54) NOTIFICATION MESSAGES GENERATED BY A GENERATIVE LANGUAGE MODEL

(71) Applicant: Shopify Inc., Ottawa (CA)

(72) Inventor: Ramanan Sampath, Seattle, WA (US)

(21) Appl. No.: 18/354,908

(22) Filed: Jul. 19, 2023

Related U.S. Application Data
(60) Provisional application No. 63/460,937, filed on Apr. 21, 2023.

(51) Int. Cl. G06F 9/54; G06Q 10/08

(52) U.S. Cl. CPC G06F 9/542; G06F 9/546; G06Q 10/08

(57) ABSTRACT

One or more computer systems which provide services to a user may react to at least one event occurring in the systems by sending notification messages to the user. It may be undesirable for the user to receive a multitude of such notification messages over a short period of time, which are caused by a same or related event, and/or which provide conflicting instructions. In some embodiments, a notification server may: aggregate a plurality of event messages to form an input prompt, the plurality of event messages associated with at least one event occurring in at least one computer system; input the input prompt into a generative language model to generate a notification message based on the plurality of event messages; and transmit the notification message to a user device instead of the plurality of event messages.

### CROSS-REFERENCE TO RELATED APPLICATIONS

This application claims the benefit of U.S. provisional patent application No. 63/460,937, titled “NOTIFICATION MESSAGES GENERATED BY AN LLM”, filed on Apr. 21, 2023, the contents of which are herein incorporated by reference in their entirety.

### BACKGROUND

Generative language models can be large neural network predictive models which determine probabilities for a next word conditional on previous words or historical words. Large language models (LLMs) are an example of a generative language model. LLMs may be responsive to input prompts including one or more of input data, context and examples.

### SUMMARY

Software platforms often include one or more computer systems providing services to a user. These systems may react to an event occurring in the systems which impacts a user by sending notification messages to the user describing the event. However, modern software platforms often include a number of different systems providing different services. These systems and services may be interrelated. For example, a particular event may affect multiple systems and each system may generate its own notification message in response. Additionally, a particular event may affect one system, but may also cause a subsequent event which may affect another system, and the separate systems may again generate their own notification messages. Further still, unrelated events impacting a particular user may occur over a short period of time, and the systems may generate and transmit a separate notification message for each unrelated event over that short period of time. It may be desirable to aggregate multiple notification messages to be transmitted to a single user into a single notification message, so that the user does not receive a multitude of notification messages.

However, due to the number of systems in modern software platforms, the number of potential events which may occur in each system, and the number of different messages which may be generated by the systems in response to such events, it may not be practical or feasible to manually pre-write these single notification messages for each possible permutation of systems, events and messages. Additionally, manually pre-written notification messages may not be responsive to addition of further systems and services or removal of legacy systems and services, and may need to be significantly re-written in order to accommodate any such changes. Further, maintaining and updating a repository of such single notification messages, and retrieving the single notification messages therefrom, may be burdensome, particularly if the stored notification messages are often re-written in order to accommodate changes to the software platform. Further still, some systems may become unreachable in certain situations or become unreliable, which may delay, or otherwise impact, any pre-written notification message being sent to the user.

In some embodiments herein, a software platform may include a notification server which aggregates a plurality of event messages received from different systems into an input prompt for a generative language model to generate a notification message (e.g., an aggregation notification message) therefrom. The plurality of event messages are not sent to the user device. Instead, the aggregation notification message generated by the generative language model is sent to the user device. The aggregation notification message may alert the user associated with the user device of at least one event occurring in the different system, and possibly includes actions to take in response to the at least one event. Technical benefits of some embodiments include the integration of a machine learning model (e.g., a generative language model) to reduce the number of notification messages transmitted to a user device (thereby saving network bandwidth between the software platform and the user device) and to provide a single notification message of machine-generated text (both content and syntax) that is based on both vast amounts of previously learned text and the aggregated plurality of event messages in order to provide output more likely to evoke a required response from a user, thereby enhancing user-system interaction. Other technical benefits of at least some embodiments include the ability to generate notification messages which are based on context associated with a particular user, including previous messages (e.g., a number and content of both previous event messages and/or previous aggregated notification messages) received by the particular user, a device type that the particular user typically views messages on, a time of day or time of week that the particular user typically views messages, etc. Other technical benefits of at least some embodiments include the ability to generate notification messages which are responsive to responses and response rates of users, and to further adapt the generated notification messages in response to user responses and user response rates as needed. Other technical benefits of at least some embodiments include the reduction of manual interaction and reduction of storage requirements by elimination of pre-written notification messages. Other technical benefits of at least some embodiments include versatility provided by the generative language model to accommodate a large number of different system events, in different orders or combinations, including ability to adapt to different types of events and different types of event messages over time, due at least in part to the previously learned behavior of the generative language model during training. Other technical benefits of at least some embodiments include the ability to leverage a pre-trained generative language model that is only fine-tuned through training to provide desired notification messages, thereby reducing training time and resources because only fine-tuning of the generative language model is needed rather than training the generative language model from scratch. Other technical benefits of at least some embodiments include the ability to use the user responses and user response rates to further train and/or fine-tune the generative language model to generate more effective notification messages which are better received by users and/or better at prompting users to perform a particular action. Use of user responses and/or user response rates to the aggregation notification message can also reduce a need for an operator of the notification server to seek active feedback from a user on the quality of the aggregation notification messages, as such feedback is implicitly provided by the user's response (or lack thereof) to the aggregation notification message.

According to one embodiment, a computer-implemented method is provided. The computer-implemented method may include: aggregating a plurality of event messages to form an input prompt, the plurality of event messages associated with at least one event occurring in at least one computer system; inputting the input prompt into a generative language model to generate a notification message based on the plurality of event messages; and transmitting the notification message to a user device.

In some embodiments, the at least one event may include a plurality of related events.

In some embodiments, the plurality of related events may include a root event and a dependent event having a dependency relationship with the root event. The plurality of event messages may include an event message associated with the root event and an event message associated with the dependent event.

In some embodiments, the computer-implemented method may further include aggregating the plurality of event messages as the input prompt in response to an aggregation trigger.

In some embodiments, the aggregation trigger may include a duration of time having elapsed.

In some embodiments, the aggregation trigger may include a duration of time having elapsed since an earlier event message of the plurality of event messages.

In some embodiments, the duration of time may be based on an event associated with the earlier event message.

In some embodiments, the computer-implemented method may further include receiving a further event message after the earlier event message during the duration of time and adding the further event message to the input prompt.

In some embodiments, the aggregation trigger may be based on at least one of a relative priority between the plurality of event messages or a priority of an earlier event message of the plurality of event messages.

In some embodiments, the generative language model may include a pre-trained generative language model, that was fine-tuned by creating a training set based on at least training input prompts and training notification messages and fine-tune training the pre-trained generative language model using the training set.

In some embodiments, creating the training set may include: associating a training input prompt with a training notification message as a training pair, the training input prompt comprising an aggregation of a training plurality of event messages; and generating a plurality of the training pairs. The plurality of the training pairs may form the training set.

In some embodiments, creating the training set may include: generating a training plurality of notification messages based on a particular training input prompt; associating each of the training plurality of notification messages with a corresponding rank as a training pair; and creating a plurality of the training pairs, wherein the plurality of the training pairs form the training set.

In some embodiments, the input prompt may further include text representing input prompt context associated with one or more of the plurality of event messages. The input prompt context may include an indication of at least one of: a relative priority between the plurality of event messages, an event message associated with a high priority event, an event message associated with a root event, features of a desired notification message, one or more examples of the desired notification message, or any prior notification messages transmitted to the user device.

In some embodiments, the notification message may include text representing at least one action to respond to the at least one event.

In some embodiments, the notification message may include text identifying at least one of a priority event of the at least one event or a root event of the at least one event.

According to another embodiment, a system is provided. The system may include at least one processor and a non-transitory computer-readable storage medium. The non-transitory computer-readable storage medium may store instructions which, when executed by the at least one processor, cause the at least one processor to: aggregate a plurality of event messages to form an input prompt, the plurality of event messages associated with at least one event occurring in at least one computer system; input the input prompt into a generative language model to generate a notification message based on the plurality of event messages; and transmit the notification message to a user device.

In some embodiments, the non-transitory computer-readable storage medium may further store instructions that, when executed, cause the at least one processor to aggregate the plurality of event messages as the input prompt in response to an aggregation trigger.

In some embodiments, the generative language model may include a pre-trained generative language model. The non-transitory computer-readable storage medium may further store instructions that, when executed, cause the at least one processor to: create a training set based on at least training input prompts and training notification messages; and fine-tune train the pre-trained generative language model using the training set.

In some embodiments, the input prompt may further include text representing input prompt context associated with one or more of the plurality of event messages. The input prompt context may include an indication of at least one of: a relative priority between the plurality of event messages, an event message associated with a high priority event, an event message associated with a root event, features of a desired notification message, one or more examples of the desired notification message, or any prior notification messages transmitted to the user device.

In some embodiments, the notification message may include text representing at least one action to respond to the at least one event.

According to another embodiment, a non-transitory computer-readable storage medium is provided. The non-transitory computer-readable storage medium may have stored thereon computer-executable instruction that, when executed, cause at least one processor to perform operations comprising: aggregating a plurality of event messages to form an input prompt, the plurality of event messages associated with at least one event occurring in at least one computer system; inputting the input prompt into a generative language model to generate a notification message based on the plurality of event messages; and transmitting the notification message to a user device.

### BRIEF DESCRIPTION OF THE DRAWINGS

Reference will now be made, by way of example, to the accompanying drawings which show example embodiments of the present application, and in which:

FIG. 1A is a block diagram of a simplified convolutional neural network, which may be used in examples of the present disclosure;

FIG. 1B is a block diagram of a simplified transformer neural network, which may be used in examples of the present disclosure;

FIG. 2 is a block diagram of an example computing system, which may be used to implement examples of the present disclosure;

FIG. 3 is a block diagram of a software platform in accordance with one embodiment;

FIG. 4 is a schematic of a notification server of the software platform of FIG. 1 in accordance with one embodiment;

FIG. 5 is a flowchart of an aggregate event messages process performed at the notification server of FIG. 4 in accordance with one embodiment;

FIG. 6 is a flowchart of computer-implemented method for using a generative language model to generate a notification message based on an input prompt comprising an aggregation of a plurality of event messages performed at the notification server of FIG. 4 in accordance with one embodiment;

FIG. 7 is a block diagram of a software platform in accordance with another embodiment incorporating an example e-commerce platform;

FIG. 8 is a block diagram of the e-commerce platform of FIG. 7 in accordance with one embodiment; and

FIG. 9 illustrates a home page of an administrator of the e-commerce platform of FIG. 8, according to one embodiment.

### DETAILED DESCRIPTION

### Neural Networks and Machine Learning

To assist in understanding the present disclosure, some concepts relevant to neural networks and machine learning (ML) are first discussed.

Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which need not be discussed in detail here.

A deep neural network (DNN) is a type of neural network having multiple layers and/or a large number of neurons. The term DNN may encompass any neural network having multiple layers, including convolutional neural networks (CNNs), recurrent neural networks (RNNs), and multilayer perceptrons (MLPs), among others.

DNNs are often used as ML-based models for modeling complex behaviors (e.g., human language, image recognition, object classification, etc.) in order to improve accuracy of outputs (e.g., more accurate predictions) such as, for example, as compared with models with fewer layers. In the present disclosure, the term “ML-based model” or more simply “ML model” may be understood to refer to a DNN. Training a ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model. For example, to train a ML model that is intended to model human language (also referred to as a language model), the training dataset may be a collection of text documents, referred to as a text corpus (or simply referred to as a corpus). The corpus may represent a language domain (e.g., a single language), a subject domain (e.g., scientific papers), and/or may encompass another domain or domains, be they larger or smaller than a single language or subject domain. For example, a relatively large, multilingual and non-subject-specific corpus may be created by extracting text from online webpages and/or publicly available social media posts. In another example, to train a ML model that is intended to classify images, the training dataset may be a collection of images. Training data may be annotated with ground truth labels (e.g., each data entry in the training dataset may be paired with a label), or may be unlabeled.

Training a ML model generally involves inputting into an ML model (e.g., an untrained ML model) training data to be processed by the ML model, processing the training data using the ML model, collecting the output generated by the ML model (e.g., based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or may be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data may be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters may be determined based on the measured performance of one or more of the trained ML models, and the first step of training (i.e., with the training set) may begin again on a different ML model described by the new set of determined hyperparameters. In this way, these steps may be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training a ML model. Backpropagation is used to adjust (also referred to as update) the value of the parameters in the ML model, with the goal of optimizing the objective function. For example, a defined loss function is calculated by forward propagation of an input to obtain an output of the ML model and comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively, so that the loss function is converged or minimized. Other techniques for learning the parameters of the ML model may be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters may then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of a ML model typically involves further training the ML model on a number of data samples (which may be smaller in number/cardinality than those used to train the model initially) that closely target the specific task. For example, a ML model for generating natural language that has been trained generically on publicly-available text corpuses may be, e.g., fine-tuned by further training using the complete works of Shakespeare as training data samples (e.g., where the intended use of the ML model is generating a scene of a play or other textual content in the style of Shakespeare).

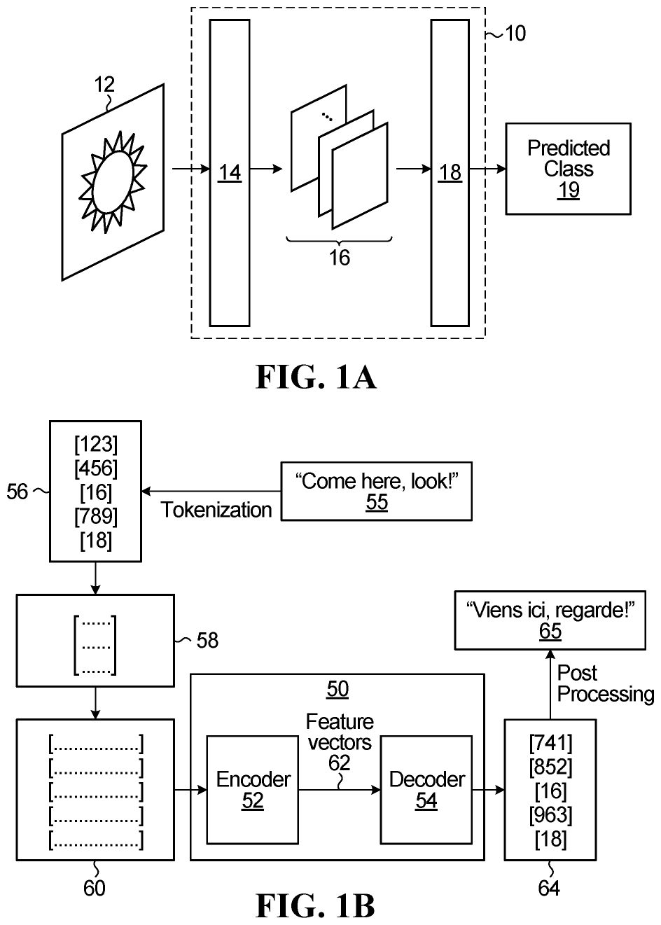

FIG. 1A is a simplified diagram of an example CNN 10, which is an example of a DNN that is commonly used for image processing tasks such as image classification, image analysis, object segmentation, etc. an input to the CNN 10 may be a 2D RGB image 12.

The CNN 10 includes a plurality of layers that process the image 12 in order to generate an output, such as a predicted classification or predicted label for the image 12. For simplicity, only a few layers of the CNN 10 are illustrated including at least one convolutional layer 14. The convolutional layer 14 performs convolution processing, which may involve computing a dot product between the input to the convolutional layer 14 and a convolution kernel. A convolutional kernel is typically a 2D matrix of learned parameters that is applied to the input in order to extract image features. Different convolutional kernels may be applied to extract different image information, such as shape information, color information, etc.

The output of the convolution layer 14 is a set of feature maps 16 (sometimes referred to as activation maps). Each feature map 16 generally has smaller width and height than the image 12. The set of feature maps 16 encode image features that may be processed by subsequent layers of the CNN 10, depending on the design and intended task for the CNN 10. In this example, a fully connected layer 18 processes the set of feature maps 16 in order to perform a classification of the image, based on the features encoded in the set of feature maps 16. The fully connected layer 18 contains learned parameters that, when applied to the set of feature maps 16, outputs a set of probabilities representing the likelihood that the image 12 belongs to each of a defined set of possible classes. The class having the highest probability may then be outputted as the predicted classification 19 for the image 12.

In general, a CNN may have different numbers and different types of layers, such as multiple convolution layers, max-pooling layers and/or a fully connected layer, among others. The parameters of the CNN may be learned through training, using data having ground truth labels specific to the desired task (e.g., class labels if the CNN is being trained for a classification task, pixel masks if the CNN is being trained for a segmentation task, text annotations if the CNN is being trained for a captioning task, etc.), as discussed above.

Some concepts in ML-based language models are now discussed. It may be noted that, while the term “language model” has been commonly used to refer to a ML-based language model, there could exist non-ML language models. In the present disclosure, the term “language model” may be used as shorthand for ML-based language model (i.e., a language model that is implemented using a neural network or other ML architecture), unless stated otherwise. For example, unless stated otherwise, “language model” encompasses LLMs.

A language model may use a neural network (typically a DNN) to perform natural language processing (NLP) tasks such as language translation, image captioning, grammatical error correction, and language generation, among others. A language model may be trained to model how words relate to each other in a textual sequence, based on probabilities. A language model may contain hundreds of thousands of learned parameters or in the case of a large language model (LLM) may contain millions or billions of learned parameters or more.

In recent years, there has been interest in a type of neural network architecture, referred to as a transformer, for use as language models. For example, the Bidirectional Encoder Representations from Transformers (BERT) model, the Transformer-XL model and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as RNN-based language models.

FIG. 1B is a simplified diagram of an example transformer 50, and a simplified discussion of its operation is now provided. The transformer 50 includes an encoder 52 (which may comprise one or more encoder layers/blocks connected in series) and a decoder 54 (which may comprise one or more decoder layers/blocks connected in series). Generally, the encoder 52 and the decoder 54 each include a plurality of neural network layers, at least one of which may be a self-attention layer. The parameters of the neural network layers may be referred to as the parameters of the language model.

The transformer 50 may be trained on a text corpus that is labelled (e.g., annotated to indicate verbs, nouns, etc.) or unlabeled. LLMs may be trained on a large unlabeled corpus. Some LLMs may be trained on a large multi-language, multi-domain corpus, to enable the model to be versatile at a variety of language-based tasks such as generative tasks (e.g., generating human-like natural language responses to natural language input).

An example of how the transformer 50 may process textual input data is now described. Input to a language model (whether transformer-based or otherwise) typically is in the form of natural language as may be parsed into tokens. It should be appreciated that the term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph, etc.) into a sequence of shorter segments that are converted to numerical representations referred to as tokens (or “compute tokens”). Typically, a token may be an integer that corresponds to the index of a text segment (e.g., a word) in a vocabulary dataset. Often, the vocabulary dataset is arranged by frequency of use. Commonly occurring text, such as punctuation, may have a lower vocabulary index in the dataset and thus be represented by a token having a smaller integer value than less commonly occurring text. Tokens frequently correspond to words, with or without whitespace appended. In some examples, a token may correspond to a portion of a word. For example, the word “lower” may be represented by a token for [low] and a second token for [er]. In another example, the text sequence “Come here, look!” may be parsed into the segments [Come], [here], [,], [look] and [!], each of which may be represented by a respective numerical token. In addition to tokens that are parsed from the textual sequence (e.g., tokens that correspond to words and punctuation), there may also be special tokens to encode non-textual information. For example, a [CLASS] token may be a special token that corresponds to a classification of the textual sequence (e.g., may classify the textual sequence as a poem, a list, a paragraph, etc.), a [EOT] token may be another special token that indicates the end of the textual sequence, other tokens may provide formatting information, etc.

In FIG. 1B, a short sequence of tokens 56 corresponding to the text sequence “Come here, look!” 55 is illustrated as input to the transformer 50. Tokenization of the text sequence into the tokens 56 may be performed by some pre-processing tokenization module such as, for example, a byte pair encoding tokenizer (the “pre” referring to the tokenization occurring prior to the processing of the tokenized input by the LLM), which is not shown in FIG. 1B for simplicity. In general, the token sequence that is inputted to the transformer 50 may be of any length up to a maximum length defined based on the dimensions of the transformer 50 (e.g., such a limit may be 2048 tokens in some LLMs). Each token 56 in the token sequence is converted into an embedding vector 60 (also referred to simply as an embedding). An embedding 60 is a learned numerical representation (such as, for example, a vector) of a token that captures some semantic meaning of the text segment represented by the token 56. The embedding 60 represents the text segment corresponding to the token 56 in a way such that embeddings corresponding to semantically-related text are closer to each other in a vector space than embeddings corresponding to semantically-unrelated text. For example, assuming that the words “look”, “see”, and “cake” each correspond to, respectively, a “look” token, a “see” token, and a “cake” token when tokenized, the embedding 60 corresponding to the “look” token will be closer to another embedding corresponding to the “see” token in the vector space, as compared to the distance between the embedding 60 corresponding to the “look” token and another embedding corresponding to the “cake” token. The vector space may be defined by the dimensions and values of the embedding vectors. Various techniques may be used to convert a token 56 to an embedding 60. For example, another trained ML model may be used to convert the token 56 into an embedding 60. In particular, another trained ML model may be used to convert the token 56 into an embedding 60 in a way that encodes additional information into the embedding 60 (e.g., a trained ML model may encode positional information about the position of the token 56 in the text sequence into the embedding 60). In some examples, the numerical value of the token 56 may be used to look up the corresponding embedding in an embedding matrix 58 (which may be learned during training of the transformer 50).

The generated embeddings 60 are input into the encoder 52. The encoder 52 serves to encode the embeddings 60 into feature vectors 62 that represent the latent features of the embeddings 60. The encoder 52 may encode positional information (i.e., information about the sequence of the input) in the feature vectors 62. The feature vectors 62 may have very high dimensionality (e.g., on the order of thousands or tens of thousands), with each element in a feature vector 62 corresponding to a respective feature. The numerical weight of each element in a feature vector 62 represents the importance of the corresponding feature. The space of all possible feature vectors 62 that can be generated by the encoder 52 may be referred to as the latent space or feature space.

Conceptually, the decoder 54 is designed to map the features represented by the feature vectors 62 into meaningful output, which may depend on the task that was assigned to the transformer 50. For example, if the transformer 50 is used for a translation task, the decoder 54 may map the feature vectors 62 into text output in a target language different from the language of the original tokens 56. Generally, in a generative language model, the decoder 54 serves to decode the feature vectors 62 into a sequence of tokens. The decoder 54 may generate output tokens 64 one by one. Each output token 64 may be fed back as input to the decoder 54 in order to generate the next output token 64. By feeding back the generated output and applying self-attention, the decoder 54 is able to generate a sequence of output tokens 64 that has sequential meaning (e.g., the resulting output text sequence is understandable as a sentence and obeys grammatical rules). The decoder 54 may generate output tokens 64 until a special [EOT] token (indicating the end of the text) is generated. The resulting sequence of output tokens 64 may then be converted to a text sequence in post-processing. For example, each output token 64 may be an integer number that corresponds to a vocabulary index. By looking up the text segment using the vocabulary index, the text segment corresponding to each output token 64 can be retrieved, the text segments can be concatenated together and the final output text sequence (in this example, “Viens ici, regarde!” 65) can be obtained.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that may be considered to be an encoder-only language model. A decoder-only language model accepts embeddings as input and may use auto-regression to generate an output text sequence. Transformer-XL and GPT-type models may be language models that are considered to be decoder-only language models.

Because GPT-type language models tend to have a large number of parameters, these language models may be considered LLMs. An example GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2048 input tokens), and is able to generate a large number of tokens as output (e.g., up to 2048 tokens). GPT-3 has been trained as a generative model, meaning that it can process input text sequences to predictively generate a meaningful output text sequence. ChatGPT is built on top of a GPT-type LLM, and has been fine-tuned with training datasets based on text-based chats (e.g., chatbot conversations). ChatGPT is designed for processing natural language, receiving chat-like inputs and generating chat-like outputs.

A computing system may access a remote language model (e.g., a cloud-based language model), such as ChatGPT or GPT-3, via a software interface (e.g., an application programming interface (API)). Additionally or alternatively, such a remote language model may be accessed via a network such as, for example, the Internet. In some implementations such as, for example, potentially in the case of a cloud-based language model, a remote language model may be hosted by a computer system as may include a plurality of cooperating (e.g., cooperating via a network) computer systems such as may be in, for example, a distributed arrangement. Notably, a remote language model may employ a plurality of processors (e.g., hardware processors such as, for example, processors of cooperating computer systems). Indeed, processing of inputs by an LLM may be computationally expensive/may involve a large number of operations (e.g., many instructions may be executed/large data structures may be accessed from memory) and providing output in a required timeframe (e.g., real-time or near real-time) may require the use of a plurality of processors/cooperating computing devices as discussed above.

Inputs to an LLM may be referred to as a prompt, which is a natural language input that includes instructions to the LLM to generate a desired output. A computing system may generate a prompt that is provided as input to the LLM via its API. As described above, the prompt may optionally be processed or pre-processed into a token sequence prior to being provided as input to the LLM via its API. A prompt can include one or more examples of the desired output, which provides the LLM with additional information to enable the LLM to better generate output according to the desired output. Additionally or alternatively, the examples included in a prompt may provide inputs (e.g., example inputs) corresponding to/as may be expected to result in the desired outputs provided. A one-shot prompt refers to a prompt that includes one example, and a few-shot prompt refers to a prompt that includes multiple examples. A prompt that includes no examples may be referred to as a zero-shot prompt.

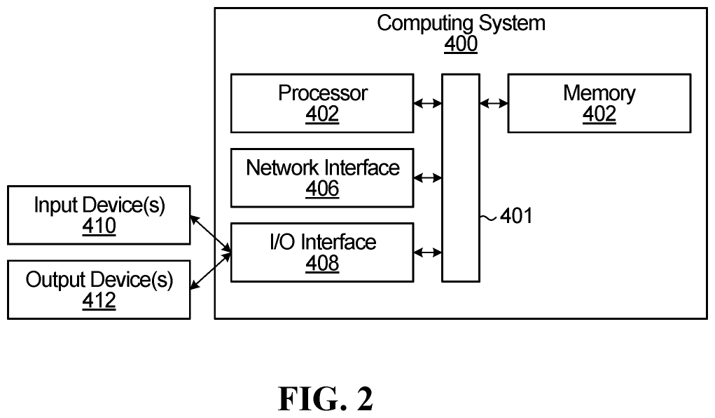

FIG. 2 illustrates an example computing system 400, which may be used to implement examples of the present disclosure, such as a prompt generation engine to generate prompts to be provided as input to a language model such as an LLM. Additionally or alternatively, one or more instances of the example computing system 400 may be employed to execute the LLM. For example, a plurality of instances of the example computing system 400 may cooperate to provide output using an LLM in manners as discussed above.

The example computing system 400 includes at least one processing unit, such as a processor 402, and at least one physical memory 404. The processor 402 may be, for example, a central processing unit, a microprocessor, a digital signal processor, an application-specific integrated circuit (ASIC), a field-programmable gate array (FPGA), a dedicated logic circuitry, a dedicated artificial intelligence processor unit, a graphics processing unit (GPU), a tensor processing unit (TPU), a neural processing unit (NPU), a hardware accelerator, or combinations thereof. The memory 404 may include a volatile or non-volatile memory (e.g., a flash memory, a random access memory (RAM), and/or a read-only memory (ROM)). The memory 404 may store instructions for execution by the processor 402, to the computing system 400 to carry out examples of the methods, functionalities, systems and modules disclosed herein.

The computing system 400 may also include at least one network interface 406 for wired and/or wireless communications with an external system and/or network (e.g., an intranet, the Internet, a P2P network, a WAN and/or a LAN). A network interface may enable the computing system 400 to carry out communications (e.g., wireless communications) with systems external to the computing system 400, such as a language model residing on a remote system.

The computing system 400 may optionally include at least one input/output (I/O) interface 408, which may interface with optional input device(s) 410 and/or optional output device(s) 412. Input device(s) 410 may include, for example, buttons, a microphone, a touchscreen, a keyboard, etc. Output device(s) 412 may include, for example, a display, a speaker, etc. In this example, optional input device(s) 410 and optional output device(s) 412 are shown external to the computing system 400. In other examples, one or more of the input device(s) 410 and/or output device(s) 412 may be an internal component of the computing system 400.

A computing system, such as the computing system 400 of FIG. 2, may access a remote system (e.g., a cloud-based system) to communicate with a remote language model or LLM hosted on the remote system such as, for example, using an application programming interface (API) call. The API call may include an API key to enable the computing system to be identified by the remote system. The API call may also include an identification of the language model or LLM to be accessed and/or parameters for adjusting outputs generated by the language model or LLM, such as, for example, one or more of a temperature parameter (which may control the amount of randomness or “creativity” of the generated output) (and/or, more generally some form of random seed as serves to introduce variability or variety into the output of the LLM), a minimum length of the output (e.g., a minimum of 10 tokens) and/or a maximum length of the output (e.g., a maximum of 1000 tokens), a frequency penalty parameter (e.g., a parameter which may lower the likelihood of subsequently outputting a word based on the number of times that word has already been output), a “best of” parameter (e.g., a parameter to control the number of times the model will use to generate output after being instructed to, e.g., produce several outputs based on slightly varied inputs). The prompt generated by the computing system is provided to the language model or LLM and the output (e.g., token sequence) generated by the language model or LLM is communicated back to the computing system. In other examples, the prompt may be provided directly to the language model or LLM without requiring an API call. For example, the prompt could be sent to a remote LLM via a network such as, for example, as or in message (e.g., in a payload of a message).

Embodiments herein relate to a generative language model, such as an LLM (e.g., an LLM as described above), to receive an input prompt that includes a plurality of event messages possibly received from different computer systems, and to generate an aggregation notification message therefrom. The embodiments described below are presented in the context of a software platform in e-commerce. However, the methods and systems are not limited to e-commerce and are instead applicable to any software platform in which one or more computer systems provide services to a user and respond to one or more events occurring in the computer system by generating event messages.

### Service Systems 502

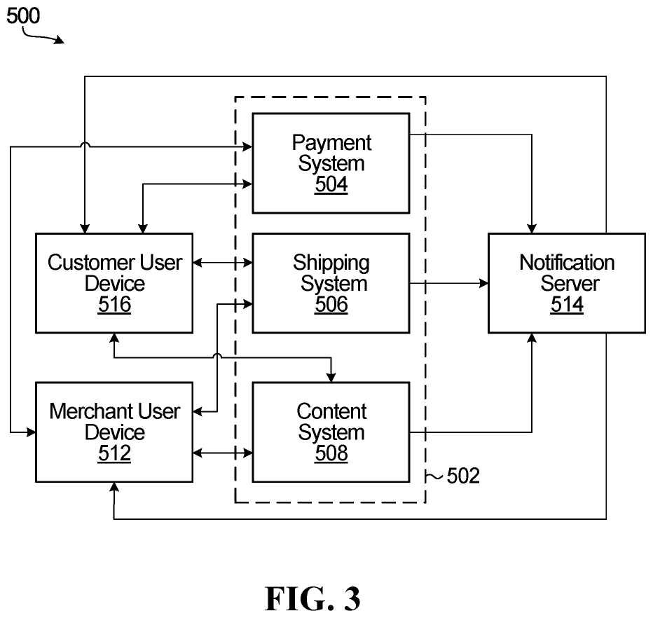

Referring now to FIG. 3, a block diagram illustrating a software platform which may provide users, such as merchants users and customer users, with services is generally shown at 500. The services may be implemented using one or more service systems shown generally at 502 and described in greater detail below. In the example shown, the service systems 502 includes a payment system 504, a shipping system 506, and a content system 508; in other embodiments, the service systems 502 may include fewer, additional or alternative service systems; in yet other embodiments and as described above, the service systems 502 and the software platform 500 may not be limited to service systems and a software platform in e-commerce. The payment system 504, the shipping system 506 and the content system 508 may each directly communicate with a merchant user device 512 associated with a merchant user and/or a customer user device 516 associated with a customer user to provide services to the merchant user and/or the customer user. In embodiments where the service systems 502 and the software platform 500 are not service systems and a software platform in e-commerce, the service systems 502 may communicate with any user device associated with users that the service systems 502 provide services to. The services offered by one system of the service systems 502 may be provided independent of the services offered by another system, but may also be related or dependent on the services offered by another system, as described below. The systems of the service systems 502 may comprise any computer or program that provides services to other computers, programs, or user devices either in the same computer or over a network such as the internet. As non-limiting examples, the payment system 504, the shipping system 506 and the content system 508 may be application, communication, mail, database, proxy, fax, file, media, web, peer-to-peer, standalone, software, or hardware servers (i.e., server computers) and may use any server format know to one of ordinary skill in the art.

Different types of services offered by the systems of the service systems 502 are described below and should be interpreted as non-limiting examples; in other embodiments, a particular system may provide fewer, additional or alternative services; further, in embodiments where the service systems 502 are not service systems in e-commerce, the service systems 502 may offer any service to a user. In some embodiments, the service systems 502 may facilitate delivering content to the customer user device 516 on behalf of the merchant user associated with the merchant user device 512 via the content system 508. The expression “content” as used herein refers to any information which can be made available electronically to the customer user device 516 or the merchant user device 512 and may include websites, webapps, computer applications, mobile applications, multimedia content such as image data, audio data and video data, etc. In some embodiments, the content delivered by the content system 508 comprises an online store which allows customer users to browse and purchase products and/or services available from the merchant user. In other embodiments, the content delivered by the content system 508 may comprise different types of websites or web apps of, or multimedia content generated by, the merchant user. To facilitate delivering content, in some embodiments, the content system 508 comprises a plurality of computer subsystems, including, without limitation, an origin server subsystem which hosts the content on of the merchant user, a content delivery network subsystem which facilitates delivery of the content to a variety of different regions of the world, a domain registration subsystem which allows the merchant user to register a domain name for the online store, a marketing subsystem which allows the merchant user to advertise the online store, etc. In the embodiment shown, these subsystems of the content system 508 are internal systems or services offered with in the software platform 500 environment; in other embodiments, these subsystems may be external systems or services offered by third parties who independently communicate with the merchant user device 512 and/or customer user device 516 outside of the software platform 500 environment.

Further, in some embodiments, the service systems 502 may facilitate monetary transactions between the customer user associated with the customer user device 516 and the merchant user associated with the merchant user device 512 via the payment system 504. To facilitate such transactions, in some embodiments, the payment system 504 comprises a plurality of computer subsystems, including, without limitation, a payment gateway subsystem for accepting payment information, a traditional payment processor subsystem for verifying payment information with external entities such as a bank subsystem, an installment payment processor subsystem implementing an installment payment plan in conjunction with external entities such as the bank subsystem, the bank subsystem of a bank associated with the customer user and/or the merchant user, an identity verification subsystem for verifying an identity of the customer user prior to allowing purchases at the online store and/or for verifying an identity of the merchant user prior to disbursing funds from the traditional payment processor subsystem or the installment payment processor subsystem, etc. In the embodiment shown, these subsystems of the payment system 504 are internal systems or services offered within the software platform 500 environment; in other embodiments, these subsystems may be external systems or services offered by third parties outside of the software platform 500 environment.

Further still, in some embodiments, the service systems 502 may facilitate shipment of products between the customer user and the merchant user via the shipping system 506. To facilitate such shipments, the shipping system 506 may comprise a plurality of computer subsystems, including, without limitation, a shipping courier subsystem, a tax subsystem, etc. Again, in the embodiment shown, these subsystems of the shipping system 506 are internal systems or services offered within the software platform 500 environment; in other embodiments, these subsystems may instead be external systems or services offered by third parties outside of the software platform 500 environment.

An event occurring in one or more systems (or subsystems) of the service systems 502, which affect or otherwise impact a particular user (e.g., the merchant user or the customer user), may cause the one or more systems (or subsystems) to transmit one or more notification messages to a user device (e.g., the customer user device 516 and/or the merchant user device 512) associated with that particular user. In some embodiments, an event occurring outside of the one or more systems (or subsystems) of the service systems 502 may also transmit one or more notification messages to the user device. These events occurring outside the one or more systems (or subsystems) of the service systems 502 may comprise event messages associated with applications provided by third parties, or other resources provided by third parties. The expression “event” as used herein refers to any occurrence in any computer system (or subsystem, e.g., the service systems 502) which may affect or otherwise impact a user. The expression “notification message” as used herein refers to any electronic communication which may be transmitted between any computer system (e.g., the service systems 502) and a user device associated with the user (e.g., the merchant user device 512 and/or the customer user device 516) and may include without limitation, emails sent to an email address associated with the user, SMS text messages sent to a phone number associated with the user, WiFi or cellular-data text messages sent to the email address or the phone number, application push notifications pushed to a mobile application or website application account associated with the user, etc. Generally, notification messages may include both informational content informing the user of a particular event occurring in the computer system (e.g., service systems 502) and/or actionable content informing the user of actions to take in response to the particular event occurring in the computer system (e.g., service systems 502). For example, a particular notification message may comprise: “Event X has occurred. As a result, feature Y has been disabled on your account. Please perform action Z to re-enable feature Y”.

Different types of events which occur in different systems (or subsystems) of the service systems 502, and different notification messages resulting therefrom, are described below and should be considered non-limiting examples; in other embodiments, fewer, additional or alternative events may occur in fewer, additional or alternative systems (or subsystems) of the service systems 502. As one non-limited example, an event occurring in the service systems 502 may be a creation of an account at the online store by the customer user. In response, the content system 508 may send a notification message to the customer user device 516 confirming creation of the online account and/or requesting that the customer user provide additional identifying information and/or choose alternative identifying information. An example notification message to the customer user device 516 may be: “Thank you for registering for an account with online store X. Please confirm your email address using the link below.” The content system 508 may also send a notification message to the merchant user device 512 notifying the merchant user that a new customer has created an account at the online store. Additional possible events occurring in the service systems 502 which may cause the content system 508 to generate and transmit notifications to a user device include, without limitation, the customer user subscribing or unsubscribing from an email list maintained by the merchant user, the customer user placing a particular product into a shopping cart, the merchant user banning a particular customer user, the merchant user updating terms of service or privacy policy of the online store, etc.

As another non-limiting example, another event occurring in the service systems 502 may be the customer user purchasing a particular product and/or a particular service from the online store by submitting payment information. In response, the payment system 504 may communicate with one or more of the traditional payment processor subsystem, the installment payment processor subsystem and/or the bank subsystem to authenticate the payment information. If the payment information cannot be authenticated, the payment system 504 may send a notification message to the customer user device 516 indicating an authentication failure and requesting that the customer user verify their banking details. An example notification message to the customer user device 516 may be: “Your purchase cannot be completed. Please verify or resubmit your payment information”. If the payment information can be authenticated, the payment system 504 may instead send a notification to both the customer user device 516 and the merchant user device 512 indicating that the authentication was successful and that funds have been transferred. Additional possible events occurring in the service systems 502 which may cause the payment system 504 to generate and transmit notification messages to a user device include, without limitation, the customer user opting to pay for a particular product in installment payments, the customer user submitting information to verify identity or age of prior to allowing purchases from the online store, the merchant user submitting information to verify identity prior to allowing sales on the online store and/or prior to disbursing funds, the customer user submitting a refund for a particular product, etc.

As another non-limiting example, another event occurring in the service systems 502 may be the merchant user generating a shipping label for shipping the particular product to the customer user and/or delivering the particular product to a shipping facility for shipment to the customer user. In response, the shipping system 506 may send a notification message to the merchant user device 512 including the shipping label. The shipping system 506 may also send a notification message to the customer user device 516 notifying the customer user that a shipping label has been printed and/or that the product has been dropped off at the shipping facility. An example notification message to the customer user device 516 may be: “Your package has been dropped off at a shipping facility. The projected delivery date is X.” Additional possible events occurring in the service systems 502 which may cause the shipping system 506 to transmit notification messages to a user device include, without limitation, the successful delivery of the particular product to the customer user, the customer user submitting a refund for a particular product, etc.

In some situations, a particular single event occurring in the service systems 502 may cause a single system (or subsystem) within the service systems 502 to generate multiple notification messages or may cause multiple systems (or subsystems) within the service systems 502 to generate multiple notification messages (e.g., each system may generate a single notification of the multiple notifications or each system may generate one or more notifications of the multiple notifications) to a user device. As one non-limiting example, in situations where the merchant user has installment payments enabled for purchases and where the customer user has purchased a particular product from the merchant user via installment payments, an event occurring in the service systems 502 may be the customer user initiating a return of that particular product. The initiation of the return (e.g., the single event) may cause the service systems 502 to generate a first notification (e.g., from the courier subsystem of the shipping system 506) to the merchant user device 512 notifying the merchant user that a shipping label has been transmitted to the customer user device 516 and a second notification (e.g., from the installment payment processor subsystem of the payment system 504) to the merchant user device 512 notifying the merchant user that future installment payments has been paused and/or requesting a refund of previously remitted payments.

Additionally, in some embodiments, a particular root event occurring in the service systems 502 may cause or propagate at least one dependent event within the service systems 502. The root event may occur in one system (or subsystem) of the service systems 502, and the at least one dependent event may occur in the same system (or subsystem) or in another system (or subsystem). Accordingly, the dependent events may have a dependency relationship with the root event. This dependency relationship may be determined using a dependency/priority generation process 700, and may be stored in a dependency/priority datastore 701, as described below. The root event and the at least one dependent event may respectively, or in combination, cause a single system of the service systems 502 to generate multiple notifications or may cause multiple systems to generate multiple notifications (e.g., each system may generate a single notification of the multiple notifications or each system may generate one or more notifications of the multiple notifications) to a user device. As one non-limited example, in situations where the merchant user has both traditional payments and installment payments enabled for purchase of products from the online store, a root event occurring in the service systems 502 may be the merchant user failing a verification of an identity of the merchant user. This root event may cause or propagate dependent events in the service systems 502 including, without limitation, deactivation of traditional payments to the merchant user from the traditional payment processor subsystem and deactivation of installment payments to the merchant user from the installment payment processor subsystem. The failed verification (e.g., the root event) may cause the service systems 502 to generate a first notification (e.g., from the identity verification subsystem of the payment system 504) to the merchant user device 512 notifying the merchant user of the failed identity verification and requesting that the merchant user provide additional information for identity verification. The deactivation of traditional payments (e.g., a dependent event) may cause the service systems 502 to generate a second notification (e.g., from the traditional payment processor subsystem of the payment system 504) to the merchant user device 512 notifying the merchant user that the merchant user's ability to receive traditional payments has been paused. The deactivation of installment payments (e.g., another dependent event) may cause the service systems 502 to generate a third notification (e.g., from the installment payment processor subsystem of the payment system 504) to the merchant user device 512 notifying the merchant user that the merchant user's ability to receive installment payments has also been paused.

Additionally, in some embodiments, a particular first event occurring in the service systems 502 may cause or propagate at least one related event within the service systems 502 to occur; and in some embodiments, the at least one related event may similarly cause or propagate the first event. The first event may occur in one system (or subsystem) of the service systems 502, and the at least one related event may occur in the same system (or subsystem) or in another system (or subsystem) of the service systems 502. The first event and the at least one related event may be related events which have a dependency relationship with each other. This dependency relationship may be determined with the dependency/priority generation process 700, and may be stored in the dependency/priority datastore 701, as described below. The first event and the at least one related event may respectively, or in combination, cause a single system of the service systems 502 to generate multiple notifications or may cause multiple systems to generate multiple notifications (e.g., each system may generate a single notification of the multiple notifications or each system may generate one or more notifications of the multiple notifications) to a user device.

Further still, in some situations, multiple unrelated events occurring in the service systems 502, and which may affect or otherwise impact a particular user, may occur over a short duration of time. These multiple unrelated events may occur in a single system (or subsystem) or in multiple systems (or subsystems) of the service systems 502. These multiple unrelated events may respectively cause a single system of the service systems 502 to generate multiple notifications or may cause multiple systems to generate multiple notifications (e.g., each system may generate a single notification of the multiple notifications or each system may generate one or more notifications of the multiple notifications) to a user device. As one non-limiting example, in situations where the merchant user is beginning a process for setting up the online store, multiple systems of the service systems 502 may automatically initiate marketing initiatives (e.g., the “unrelated” events occurring in the service systems 502) to prompt the merchant user to sign up for additional features. The initiation of a payment system marketing initiative (e.g., an event) may cause the service systems 502 to generate a first notification (e.g., from the payment system 504) to the merchant user device 512 notifying the merchant user of different payment services offered by the software platform 500 and prompting the merchant user to sign up for such payment services. The initiation of a shipping system marketing initiative (e.g., an unrelated second event) may cause the service systems 502 to generate a second notification (e.g., from the shipping system 506) to the merchant user device 512 notifying the merchant user of different shipping services offered by the software platform 500 and prompting the merchant user to sign up for such shipping services.

It may be undesirable for a user to receive a multitude of notification messages caused by a single event, a multitude of notification messages providing different instructions and/or a multitude of notification messages over a short period of time. It may thus be desirable to aggregate multiple notification messages into a single notification message, so that the user does not receive a multitude of notifications. However, due to the number systems (or subsystems) within the service systems 502 in the software platform 500, the number of potential events which may occur in each different system and the number of different notification messages which may be generated by each system in response to events occurring in the service systems 502, it may not be practical or feasible to manually pre-write such single notification messages for each possible permutation of systems, events and notification messages. Additionally, manually pre-written notification messages may not be responsive to addition of further systems and services to the software platform 500 or removal of legacy systems and services to the software platform 500, and may need to be significantly re-written in order to accommodate any such changes. Further, maintaining and updating a machine-readable repository of such single notification messages, and retrieving the single notification messages therefrom, may be burdensome, particularly if the stored notification messages are often re-written in order to accommodate changes to the software platform 500. Further still, certain systems within the service systems 502 may become unreachable in certain situations or become unreliable in providing notification messages, which may delay, or otherwise impact, transmission of such pre-written notification messages to a user device.

Accordingly, still referring to FIG. 3, the software platform 500 may further include a notification server 514 in communication with the service systems 502 and the user device (e.g., the merchant user device 512 and/or the customer user device 516) and which may use a generative language model, such as an LLM described above, to generate an aggregation notification message based on an input prompt. The input prompt may include an aggregation of a plurality of event messages received from the different systems of the service systems 502 described above. The expression “event message” as used herein refers to any electronic communication which may be transmitted between the service systems 502 and the notification server 514 and generally indicating that at least one event has occurred in the service systems 502. In some embodiments, the event message is caused by the at least one event occurring in the service systems 502; in other embodiments, the at least one event occurring in the service systems 502 may be caused by the event message. In some embodiments, event messages may be human-readable messages generated by the service systems 502 for direct transmission to a user device (e.g., the merchant user device 512 and/or the customer user device 516) which is now instead initially received by the notification server 514. For example, the event messages may be the various notification messages generated by the different systems (or subsystems) of the service systems 502 described above. In other embodiments, the event messages may be machine-readable message generated by the service systems 502. For example, the event message may be error messages generated by different systems of the service systems 502, such as error codes in a Kafka stream. As a more specific non-limiting example, for an event corresponding to failed authentication of payment information from the customer user, the machine-readable error message (which functions as the event message) generated by the payment system 504 may include: “error”: {“code”=101 “message”=“payment information cannot be authenticated or is declined by bank subsystem”}

As another non-limiting example, for an event corresponding to failed verification of an identity of the merchant user, the machine-readable error message (which functions as the event message) generated by the payment system 504 may include: “error”: {“code”=1002 “message”=“please verify user identity details entered and try again”}

Event messages which correspond to machine-readable messages may allow the notification server 514 to generate the aggregation notification message closer in time to when events actually occur in the service systems 502.

### Notification Server 514

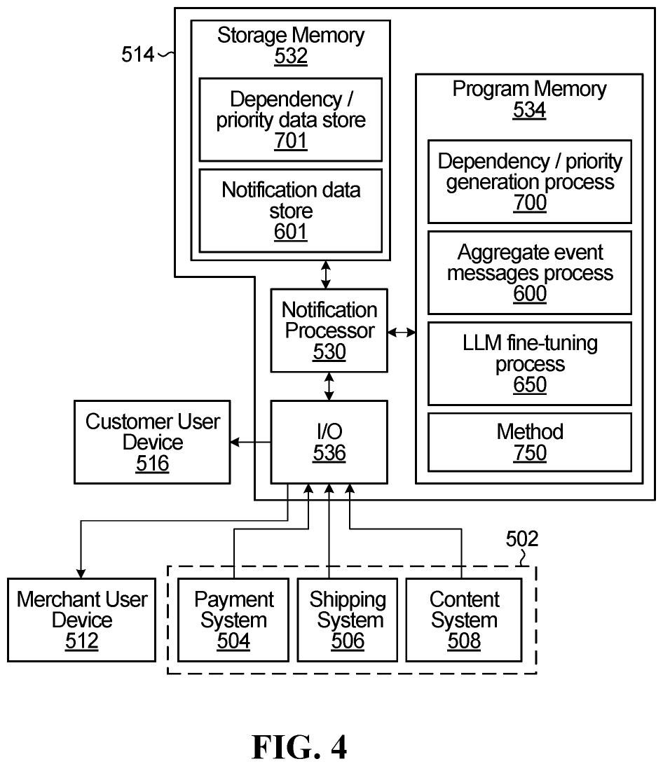

In some embodiments, the notification server 514 is similar to the example computing system 400 described above. Another embodiment of the notification server 514 is shown in FIG. 4; in this embodiment shown, the notification server 514 includes at least one notification processor 530, and a storage memory 532, a program memory 534 and an input/output (I/O) interface 536 all in communication with the notification processor 530. Other embodiments of the notification server 514 may include fewer, additional or alternative components. Additionally, although only a single notification processor 530, a single storage memory 532, a single program memory 534, and a single I/O interface 536 is shown in FIG. 4, other embodiments of the notification server 514 may include more than one of each of these components.

The storage memory 532 stores information received or generated by the notification processor 530 and may generally function as an information or datastore. In the embodiment shown, the storage memory 532 includes the dependency/priority datastore 701 and a notification datastore 601; in other embodiments, the storage memory 532 may include fewer, additional or alternative datastores. The program memory 534 stores various blocks of code (alternatively called processor, machine and/or computer executable instructions), including codes for directing the notification processor 530 to perform various processes, such as the dependency/priority generation process 700, an aggregate event messages process 600, an LLM fine-tuning process 650, and a method 750 described below. The program memory 534 may also store database management system codes for managing the datastores in the storage memory 532. In other embodiments, the program memory 534 may store fewer, additional or alternative codes for directing the notification processor 530 to execute additional or alternative functions. The storage memory 532 and the program memory 534 may each be implemented as one or a combination of a non-transitory computer-readable and/or non-transitory machine-readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching thereof). The expression “non-transitory computer-readable medium” or “non-transitory machine-readable medium” as used herein is defined to include any type of computer-readable storage device and/or storage disk and to exclude propagating signals and to exclude transmission media.

The I/O interface 536 comprises an interface for receiving and transmitting information between the notification server 514 and different systems within the service systems 502 and also for receiving and transmitting information between the notification server 514 and user devices (e.g., the merchant user device 512 and/or the customer user device 516). For example, the notification server 514 may receive the plurality of event messages (e.g., the human-readable notification messages and/or the machine-readable error messages described above) transmitted from different systems within the service systems 502 over a network (such as a wireless network or a wired network) via the I/O interface 536. As an additional non-limiting example, the notification server 514 may transmit the single aggregation notification message generated based on the plurality of event messages to the merchant user device 512 and/or the customer user device 516 via the I/O interface 536. As a further non-nonlimiting example, the notification server 514 also communicate with additional systems over the I/O interface 536, including an external model server (not shown) described below. Such an external model server may have increased processing capacity and computing resources for training and/or fine-tuning various machine learning models described herein. The I/O interface 536 may include any communication interface which enables the notification processor 530 to communicate with external components, including specialized or standard I/O interface technologies such as channel, port-mapped, asynchronous for example. In some embodiments, the I/O interface 536 may be implemented using a network interface card (NIC), a port, and/or a network socket.

The notification processor 530 is configured to execute codes stored in the program memory 534, to retrieve information from and store information into the datastores of the storage memory 532, and to receive and transmit information to service systems 502, the merchant user device 512 and the customer user device 516 over the I/O interface 536, examples of which are described below. In the embodiment shown, the notification processor 530 is a server central processing unit and may be a multi-core processor.

### Dependency/Priority Generation Process 700

Still referring to FIG. 4, in some embodiments, the notification server 514 may be configured to determine (a) at least one dependency relationship between different event messages and/or between the actual events occurring in the service systems 502 which cause the different event messages and/or (b) a relative priority between the different event messages, the different actual events, and/or the different systems in the service systems 502 which generate the different event messages. In this regard, the notification server 514 may execute the dependency/priority generation process 700 described below. In the embodiment shown, the dependency/priority generation process 700 comprises machine, processor and/or computer readable instructions stored in the program memory 534 for execution by the notification processor 530; in other embodiments, the dependency/priority generation process 700 may comprise processor, machine and/or computer readable instructions alternatively stored on other non-transitory computer readable storage medium such as a CD-ROM, a floppy disk, a hard drive, a DVD, a Blu-ray disk or another component associated with the notification server 514; in yet other embodiments, the dependency/priority generation process 700 and/or parts thereof could alternatively be executed by a device other than the notification processor 530, including for example, by the external model server.

In some embodiments, the dependency/priority generation process 700 may include codes directing the notification processor 530 to determine dependency relationships between different event messages, dependency relationships between different actual events which cause the different event messages, and/or dependency relationships between different systems (or subsystems) which generate the different event messages. For example, the notification processor 530 may generate one or more dependency graphs linking different event messages, different actual events, and/or different systems.

The notification processor 530 may generate the one or more dependency graphs from pre-requisites of services offered by different systems of the service systems 502. As a non-limiting example, a successful verification of the merchant user by the identity verification subsystem (of the payment system 504) may be a pre-requisite to both disbursement of traditional payments by the traditional payment processor subsystem and disbursement of installment payments by the installment payment processor subsystem. Accordingly, the verification of the merchant user may be assigned or labelled a “root event”, and the disbursement of traditional payments and the disbursement installment payments may both be assigned or labelled a “dependent event” having a dependency relationship with the root event or a “related event” affected by the root event. Further, in such situations, as the root event causes the dependent events and/or the related events, the root event may have a higher priority relative to the dependent events and/or the related events. In the example above, the failed identity verification root event may need to be rectified before traditional payments and installment payments may be reactivated.

Alternatively or additionally, the notification processor 530 may generate the at least one dependency graph by using a dependency generation model. The dependency generation model may be a ML model trained by inputting training pairs of event messages (caused by different events and generated by different systems) which are ground labelled with training dependency labels of at least “root event-dependent event”, “root event-related event”, “dependent event-dependent event”, “related event-related event”, “unrelated event-unrelated event” for example, to iteratively generate and optimize coefficients which enable the dependency generation model to generate a dependency relationship for different pairs of event messages based on an input of a particular pair of event messages. In some embodiments, the training dependency labels may also indicate relative priority of the pairs of event messages, such as “root event_high priority-related event_medium priority” or “root event_high priority-dependent event_low priority” for example. The dependency generation model may be trained on the notification server 514 and/or the external model server and may be locally stored in the storage memory 532. In other embodiments, the dependency generation model may be stored other storage memory within the notification server 514 and/or other storage memory within another system (or subsystem) of the software platform 500, and/or other storage memory associated with a user device (e.g., the merchant user device 512 and/or the customer user device 516). In other embodiments, the notification processor 530 may generate the at least one dependency graph by using alternative or additional ML models or statistical models which analyze the plurality of event messages; in yet other embodiments, the at least one dependency graph may also be defined by humans, such as by using the pre-requisites described above. The at least one dependency graph may be stored in association with different event messages, different actual events and/or different systems in the dependency/priority datastore 701.

In some other embodiments, the dependency/priority generation process 700 may also include codes directing the notification processor 530 to determine relative priority of different event messages received from the service systems 502, relative priority of the actual events occurring in the different systems (or subsystems) of the service systems 502 which cause the different event messages, and/or relative priority of different systems which generate the different event messages. For example, the notification processor 530 may assign priority labels to particular events, particular event messages and/or particular systems, such as “high priority”, “medium priority” and “low priority”; other embodiments may include fewer, additional or alternative priority labels, and may include numerical priority labels. As a non-limiting example, events occurring in and/or event messages generated by the payment system 504 may be assigned or labelled “high priority”, whereas events occurring in and/or event messages generated by the shipping system 506 may be assigned or labelled “medium priority” and events occurring in and/or event messages generated by the content system 508 may be assigned or labelled “low priority”. As a further non-limiting example, an event corresponding to verification of a merchant user by the identity verification subsystem of the payment system 504 (and/or an event message caused by such an event) may be assigned or labelled “high-priority”, whereas verification of a customer user by the same identity verification subsystem (and/or an event message caused by such an event) may be assigned or labelled “medium priority”.

The notification processor 530 may generate the priority labels by using a priority generation model. The priority generation model may be a ML model trained by inputting training event messages (caused by different events and generated by different systems) which are ground labelled with training priority labels of at least “high priority”, “medium priority” and “low priority” for example, to iteratively generate and optimize coefficients which enable the priority generation model to generate a priority label for different event messages based on an input of one or more event messages. The priority generation model may be trained on the notification server 514 and/or the external model server and may be locally stored in the storage memory 532. In other embodiments, the priority generation model may be stored other storage memory within the notification server 514 and/or other storage memory within another system (or subsystem) of the software platform 500 and/or other storage memory associated with a user device (e.g., the merchant user device 512 and/or the customer user device 516). In other embodiments, the notification processor 530 may generate the priority labels by using alternative or additional ML models or statistical models which analyze the plurality of event messages; in yet other embodiments, the priority labels for different event messages may also be defined by humans. The priority labels may also be stored in association with different event messages, different actual events and/or different systems in the dependency/priority datastore 701.

### Aggregate Event Messages Process 600

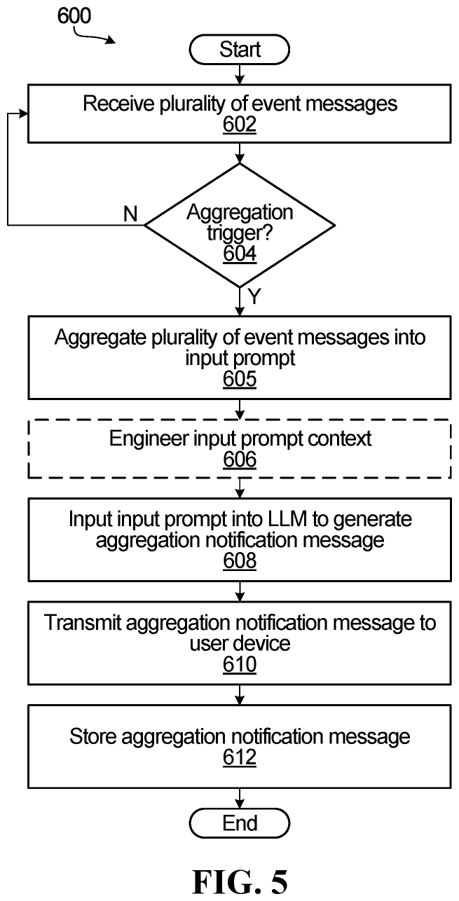

Referring to FIGS. 4 and 5, a computer-implemented aggregate event messages process for utilizing a generative language model, such as the LLMs described above, to generate an aggregation notification message based on an input prompt is generally shown at 600. The input prompt may comprise an aggregation of a plurality of event messages received from the different systems (or subsystems) of the service systems 502. Integration of a generative language model may reduce the number of notification messages transmitted to a user device (thereby saving network bandwidth between the software platform and the user device) and may provide a single aggregation notification message of machine-generated text (both content and syntax) that is based on both vast amounts of previously learned text and the aggregated plurality of event messages in order to provide output more likely to evoke a required response from a user, thereby enhancing interactions between the user (e.g., the merchant user and/or the customer user) and the system (e.g., systems of the service systems 502). For example, some embodiments include generation of notification messages which are based on context associated with a particular user, including previous messages (e.g., a number and content of both previous event messages and/or previous aggregated notification messages) received by the particular user, a device type that the particular user typically views messages on, a time of day or time of week that the particular user typically views messages, a language that the particular user prefers to communicate with, etc. Some embodiments include the ability to generate notification messages which are responsive to responses and response rates of users to previous notification messages, and to further adapt the generated notification messages in response to user responses and user response rates as needed. Further, some embodiments include the reduction of manual interaction and reduction of storage requirements by elimination of pre-written notification messages. Some embodiments include increased versatility provided by the generative language model to generate notification messages which accommodate a large number of different system events, in different orders or combinations, including the adaption of notification messages to different types of events and different types of event messages over time, due at least in part to the previously learned behavior of the generative language model during training or over time with ongoing fine-tuning. Some embodiments include the ability to leverage a pre-trained generative language model that is only fine-tuned through training to provide desired notification messages, thereby reducing training time and resources because only fine-tuning of the generative language model is needed rather than training the generative language model from scratch. Further still, some embodiments include the ability to further fine-tune generative language models to generate more effective notification messages using the user responses and user response rates to the aggregation notification messages. Use of user responses and/or user response rates to the aggregation notification message can also reduce any need for an operator of the notification server to seek active feedback from a user on the quality of the aggregation notification messages, as such feedback is implicitly provided by the user's response (or lack thereof) to the aggregation notification message.

In the embodiment shown, the aggregate event messages process 600 is performed by the notification processor 530 executing processor, machine and/or computer readable instructions stored in the program memory 534; in other embodiments, the aggregate event messages process 600 may comprise processor, machine and/or computer readable instructions alternatively stored on other non-transitory computer readable storage medium; in yet other embodiments, the aggregate event messages process 600 and/or parts thereof could alternatively be executed by a device other than the notification processor 530, including for example, by the external model server. Further, although the aggregate event messages process 600 in accordance with one embodiment is described with reference to the flowchart illustrated in FIG. 5, other methods of implementing the aggregate event messages process 600 may alternatively be used. For example, the order of execution of the blocks may be altered, and/or some of the blocks described may be altered, eliminated, or combined.

In the embodiment shown in FIG. 5, the aggregate event messages process 600 begins at block 602, which may involve causing the notification processor 530 to receive a plurality of event messages from the service systems 502. As described above, in some embodiments, the plurality of event messages may be human-readable messages generated by the service systems 502 for transmission to a user device (e.g., the merchant user device 512 and/or the customer user device 516) which are now instead initially received by the notification server 514. These human-readable messages may specifically comprise the various notification messages generated by the different systems (or subsystems) of the service systems 502 described above. In other embodiments, the plurality of event messages may be machine-readable messages generated by the service systems 502. These machine-readable messages may specifically comprise error messages generated by the different systems described above. As also described above, event messages which correspond to machine-readable messages may allow the aggregate event messages process 600 to initiate and to generate the aggregation notification message closer in time to when the events actually occur in the service systems 502, which may allow some embodiments to be more responsive to events occurring in the service systems 502.

Accordingly, similar to the various notification messages generated by different systems of the service systems 502 described above, the plurality of event messages may also result from a particular single event occurring in the service systems 502. The particular single event may cause a single system (or subsystem) within the service systems 502 to generate the plurality of event messages or may cause multiple systems (or subsystems) within the service systems 502 to generate the plurality of event messages (e.g., each system may generate a single event message of the plurality of event messages or each system may generate one or more event messages of the plurality of event messages).

The plurality of event messages may also result from a particular root event and at least one dependent event occurring in the service systems 502. The dependent events may be caused or propagated by the root event and may have a dependency relationship with the root event. The root event may occur in one system of the service systems 502, and the dependent events may occur in the same system or in another system. The root event and the at least one dependent event may respectively, or in combination, cause a single system to generate the plurality of event messages or may cause multiple systems to generate the plurality of event messages (e.g., each system may generate a single event message of the plurality of event messages or each system may generate one or more event messages of the plurality of event messages).

The plurality of event messages may also result from a first event and at least one related event occurring in the service systems 502. The first event and the at least one related event may have a dependency relationship with each other. For example, the first event may cause or propagate the at least one related event, and the at least one related event may similarly cause or propagate the first event. The first event may occur in one system of the service systems 502, and the second event may occur in the same system or in another system. The first event and the at least one related event may respectively, or in combination, cause a single system to generate the plurality of event messages or may cause multiple systems to generate the plurality of event messages (e.g., each system may generate a single event message of the plurality of event messages or each system may generate one or more event messages of the plurality of event messages).

The plurality of event messages may also result from multiple unrelated events which impact a same user (e.g., the customer user and/or the merchant user) and which occur in the service systems 502 over a short period of time. These multiple unrelated events may occur in a single system of the service systems 502 or in multiple systems. The multiple unrelated events may respectively cause a single system to generate the plurality of event messages or may cause multiple systems to generate the plurality of event messages (e.g., each system may generate a single event message of the plurality of event messages or each system may generate one or more event messages of the plurality of event messages).

The aggregate event messages process 600 then continues to block 604, which may involve causing the notification processor 530 to determine whether an aggregation trigger has occurred to aggregate the plurality of event messages into an input prompt to be inputted into the generative language model. The aggregation trigger may be based on priority labels and/or dependency relationships associated with the plurality of event messages, the actual events occurring in the service systems 502 which cause the plurality of event messages and/or the system (or subsystem) of the service systems 502 which generate the plurality of event messages. As described above, the priority labels and dependency relationships of various different event messages may be generated by the dependency/priority generation process 700 and may be stored in the dependency/priority datastore 701.

As one non-limiting example, in some embodiments, the aggregation trigger may be a duration of time elapsed since a particular event message. This particular event message may be any earlier event message of the plurality of event messages received by the notification server 514. This earlier event message may be an event message associated with a high priority event, an event message associated with a root event, an event message associated with a particular system of the service systems 502 and/or an event message associated with a high priority system. This particular event message may also be a most recent event message of the plurality of event message received by the notification server 514.

In embodiments where the particular event message is any earlier event message ((a) above), any additional event messages received during the duration of time may be included in the plurality of event messages to be aggregated to form or generate the input prompt at block 605 described below. For example, if an event message associated with a root event is received at T₀ and the aggregation trigger is a duration of time of 5 minutes (300 seconds) from receipt of the message associated with the root event, and another event message associated with a related event is received at T₁₅₀ (i.e., 150 seconds later), the event message associated with the related event may be included in the plurality of event messages to be aggregated to form or generate the input prompt. In embodiments where the particular event message is a most recent event message ((b) above), a timer for determining the duration of time may be reset every time a new event message is received at the notification server 514 from the service systems 502. Using a duration of time as the aggregation trigger may improve the reliability of generating and transmitting the aggregation notification message to a user device, particularly in situations where particular systems within the service systems 502 may become unreachable in certain situations or become unreliable in providing notification messages. For example, a particular root event may be known to cause or propagate a first dependent event, a second dependent event and a third dependent event (e.g., using the dependency/priority generation process 700 described above). However, the system for generating an event message for the third dependent event may become unreachable. An aggregation trigger based on a duration of time since the root event or based on a duration time since a most recent event message may allow the notification processor 530 to aggregate the plurality of event messages actually received at the notification server 514 into the input prompt without requiring to wait for the event message from the unreliable system.

In some embodiments, the earlier event message or the most recent event message may include a timestamp associated with when the event which caused that event message actually occurred in the service systems 502. In such embodiments, the aggregation trigger may comprise a duration of time having elapsed since the event actually occurred in the service systems 502.

The duration of time may be any duration of time, including without limitation, 5 seconds, 30 seconds, 5 minutes, 30 minutes, an hour, 12 hours, 24 hours, 48 hours, etc. The duration of time may also be varied based on priority labels and/or dependency relationships associated with the plurality of event messages, the actual events occurring in the service systems 502 which cause the plurality of event messages and/or the system (or subsystem) of the service systems 502 which generate the plurality of event messages. For example, where the plurality of event messages include an event message generated by a high priority system or associated with a high priority event, the duration of time of the aggregation trigger may be less when compared to when the plurality of event messages do not include any event messages generated by a high priority system or associated with a high priority event.

In other embodiments, the aggregation trigger may be based on a fixed time window following a particular fixed time. The particular fixed time may be a particular time of day, a particular time of week, a particular time of month or a particular time of year. The fixed time window may be any duration of time (as described above) passed since that particular fixed time. For example, the aggregation trigger may comprise a fixed time window of 14 hours between 6 PM on a first workday and 8 AM on a subsequent workday following the first workday, corresponding to a current time zone of the particular user, to avoid sending multiple event messages during off-work hours. Additionally and/or alternatively, the aggregation trigger may comprise a fixed time window of seven hours between 11 PM on a first day and 6 AM on a subsequent day after the first day, corresponding to a current time zone of the particular user, to avoid sending multiple event messages during nighttime. Additionally and/or alternatively, the aggregation trigger may comprise a fixed time window between 11:59 PM on a Friday and 12:01 AM on a following Monday to avoid sending multiple event messages during a weekend.

In other embodiments, the aggregation trigger may be based on a number of event messages received after a particular point in time. For example, the aggregation trigger may comprise a number threshold and may be triggered immediately to aggregate the plurality of event messages into the input prompt in response to receiving a particular number of event messages after the particular time. The particular number of event messages may be two messages, three messages, four messages, five messages, 10 messages, 20 messages, etc. The particular point in time may be a particular fixed time, such as a particular time of day, particular time of week, a particular time of month or a particular time of year as described above. For example, aggregation trigger may be when five messages have been received after 12 AM on any particular day. The particular point in time may also be based on time elapsed since a particular event message as described above. For example, the aggregation trigger may be when five messages have been received after any earlier event message of the plurality of event messages as described above.

In other embodiments, the aggregation trigger may be directly triggered by a particular priority label, such as the “high priority” label generated by the dependency/priority generation process 700 as described above. For example, the aggregation trigger may comprise a priority threshold and may be triggered immediately to aggregate the plurality of event messages into the input prompt in response to receiving any event message associated with a “high priority” label (such as one generated by a high-priority system and/or associated with a high-priority event).

If at block 604, the notification processor 530 determines that the aggregation trigger has not occurred, the aggregate event messages process 600 returns to block 602 to wait for and/or receive additional event messages of the plurality of event messages. However, if at block 604, the notification processor 530 determines that the aggregation trigger has occurred, the aggregate event messages process 600 continues to block 605. Block 605 may involve directing the notification processor 530 to aggregate the plurality of event messages into the input prompt to be inputted into the LLM. The input prompt may be a concatenation of the plurality of event messages.

The input prompt may also be a human-readable input prompt and/or a machine-readable input prompt. For example, in response to receiving an event message for event X, and event message for event Y, and event message for event Z, the notification processor 530 may generate a human-readable input prompt comprising: “Here are error messages from event X, event Y and event Z. Generate a human-readable notification summarizing consequences event X, Y and Z.”. Additionally or alternatively, the notification processor 530 may generate a machine-readable input prompt comprising: “prompt”: {“<error message from event X>, <error message from event Y>, <error message from event Z>”, “completion”=“summary of consequences of event X, event Y and event Z in a human-readable notification message”}

The aggregate event messages process 600 may then continue to optional block 606. Optional block 606 may involve directing the notification processor 530 to engineer the input prompt to be submitted to the LLM. Certain embodiments of the aggregate event messages process 600 might not include optional block 606, such as embodiments where the LLM has been fine-tuned to generate the aggregation notification message based on a mere aggregation of the plurality of event messages using the LLM fine-tuning process 650 described below. Embodiments of the aggregate event messages process 600 which include the optional block 606 to engineer the input prompt may allow the notification server 514 to use a pre-trained LLM to generate an aggregation notification message without any (or with minimal) further fine-tuning of the pre-trained LLM.

For example, optional block 606 may direct the notification processor 350 to engineer the input prompt by including additional input prompt context in the input prompt in addition to the plurality of event messages. The additional input prompt context may be based on priority labels and/or dependency relationships associated with the plurality of event messages, the actual events occurring in the service systems 502 which cause the plurality of event messages and/or the systems (or subsystems) of the service systems 502 which generate the plurality of event messages. As described above, the priority labels and dependency relationships between various different event messages may be generated by the dependency/priority generation process 700 and may be stored in the dependency/priority datastore 701. In this respect, the addition of a broader context may include, without limitation, A text indication of the priority labels associated with (e.g., a relative priority between) the plurality of event messages and/or between the actual events which cause the plurality of event messages. For example, the text indication may identify an event message associated with a high priority event versus an event message associated with a low priority event. As a non-limiting example, such text indication in human-readable format may include: “Event X is a high priority event, event Y is a medium priority event and event Z is a low priority event”. As a further non-limiting example, such text indication in machine-readable format may include: “prompt”: {“<error message from event X, “high priority”>, <error message from event Y, “medium priority”>, <error message from event Z, “low priority”>”,}

As an additional non-limiting example, the text indication may also identify event messages associated with a high priority system versus an event message associated with a low priority system. As a non-limiting example, such text indication in human-readable format may include: “Event X occurred in system X, which is a high priority system. Events Y and Z occurred in system Y, which is a low priority system”. As a non-limiting example, such text indication in machine-readable format may include: “prompt”: {“<error message from event X originating from system X>, <error message from event Y>, <error message from event Z>”, “context”=“event X originates from system X, event Y originates from system Y, event Z originates from system Y, high priority system X, low priority system Y”}

The addition of a broader context may further include, without limitation, a text indication of dependency relationships between the plurality of event messages and/or between actual events which caused the plurality of event messages. For example, the text indication may identify an event message associated with a root event versus an event message associated with a dependent event and/or an event message associated with a related event. As a non-limiting example, such text indication in human-readable format may include: “Event X is a root event, event Y is a dependent event caused by event X, and event Z is a related event related to event Y”. As a further non-limiting example, such text indication in machine-readable format may include: “prompt”: {“<error message from event X>, <error message from event Y>, <error message from event Z>”, “context”=“event X is root event to event Y, event Y is dependent event from event X, event Y is related event to event Y, event Z is related event to event Y”}

Additionally or alternatively, the additional input prompt context may also include a text indication of features of a desired notification message. The features of a desired notification message may include a number of words, a number of sentences, a structure of notification message, etc. As a non-limiting example, such text indication in human-readable format may include: “Here are error messages corresponding to events X, Y and Z, convert these error messages into human-readable prose and string them into a sentence of 10 words or less”. As a further non-limiting example, such text indication in machine-readable format may include: “prompt”: {“<error message from event X>, <error message from event Y>, <error message from event Z>”, “completion”=“summary of consequences of event X, event Y and event Z in a human-readable sentence of 10 words or less”}

Additionally or alternatively, the features of the desired notification message may include emphasis on particular content or an event message associated with a particular event (such as a root event or a high priority event for example). As a non-limiting example, such text indication in human-readable format may include: “Here are error messages corresponding to events X, Y and Z. Event X is a root event, event Y is a dependent event caused by event X, and event Z is a related event related to event Y. Convert these error messages into human-readable prose and emphasize actions to be taken by the user in response to root events”. As a further non-limiting example, such text indication in machine-readable format may include: “prompt”: {“<error message from event X>, <error message from event Y>, <error message from event Z>”, “context”=“event X is root event to event Y, event Y is dependent event from event X, event Y is related event to event Y, event Z is related event to event Y” “completion”=“summary of consequences of event X, event Y and event Z in a human-readable sentence with emphasis on action to take in response to root events”}

Additionally or alternatively, the features of a desired notification message may also include one or more examples of the desired notification message. As a non-limiting example, such text indication in human-readable format may include: “Here are error messages corresponding to event X, event Y, and event Z, convert these error messages into human-readable prose corresponding to the example sentence below. ‘Event X has happened in system X, which has caused event Y and event Z to happen in system Z. You need to perform action A to rectify event X, and then actions B and C to rectify events Y and Z”. As a further non-limiting example, such text indication in machine-readable format may include: “prompt”: {“<error message from event X>, <error message from event Y>, <error message from event Z>”, “completion”=“summary of consequences of event X, event Y and event Z in a human-readable sentence” “example”=“You need to perform action A to rectify event X, and then actions B and C to rectify events Y and Z”}

Additionally or alternatively, the input prompt context may also include a text indication of prior notification messages already sent to the user and/or event messages associated with such prior notification messages. Prior notification messages sent by the notification server 514 to the user device (e.g., the customer user device 516 and/or the merchant user device 512) may be stored in the notification datastore 601 at block 612 as described below. In some embodiments, the events associated with such prior notification messages may be related to, or have a dependency relationship with, one or more of the events associated with the plurality of event messages currently being aggregated into the input prompt at block 605. As a non-limiting example, such text indication in human-readable format may include: “Here are error messages corresponding to event Y and event Z. Event Y is dependent on event X and event Z is related to event Y. A prior notification message including an event message associated with event X was previously sent to this user at 10:21 AM on May 6.” As a further non-limiting example, such text indication in machine-readable format may include: “prompt”: {“<error message from event Y>, <error message from event Z>”, “context”=“event Y is dependent event from event X, event Y is related event to event Y, event Z is related event to event Y, prior notification message including error message from event X was sent to user at 10:21 AM on May 6”,} The text indication of prior notification messages can also include an indication of how many times a notification message incorporating a particular event (e.g., event X) has been sent to the user device in the past.

Additionally or alternatively, the input prompt context may also include a text indication of a user response or a user response rate to notification messages already sent to the user and/or event messages associated with such prior notification messages. As a non-limiting example, such text indication in human-readable format may include: “Here are error messages corresponding to event Y requiring action A and event Z requiring action B. A prior notification message including an event message associated with event Y and action A as well as event X and action C was previously sent to this user at 10:21 AM on June 23. At 1:00 PM on June 24, the user performed action C. The user did not perform action A”. As a further non-limiting example, such text indication in machine-readable format may include: “prompt”: {“<error message from event Y>, <error message from event Z>”, “context”=“event Y requires action A, event Z requires action B, a prior notification message including an event message associated with event Y and action A as well as event X and action C was previously sent to this user at 10:21 AM on June 23. Action C performed at 1:00 PM on June 24. Action A has not been performed.”}

Additionally or alternatively, the input prompt context may also include a text indication of context associated with a particular user and/or the user device (e.g., the customer user device 516 and/or the merchant user device 512), including a device type that the particular user typically views messages on, a message type the particular user is responsive towards, a time of day and/or time of week that the particular user typically views messages, a language that the particular user prefers to communicate with, etc. As a non-limiting example, such text indication in human-readable format may include: “Here are error messages corresponding to event Y and event Z. User checks email in the evenings on weekdays at 9 AM and on weekends at 10 AM and uses a mobile device 90% of the time”. As a further non-limiting example, such text indication in machine-readable format may include: “prompt”: {“<error message from event Y>, <error message from event Z>”, “context”=“device A, 0.9”, “device B, 0.1”, “weekday AM”, weekend AM″}

As described above, the notification processor 530 may generate the input prompt context to be added to the input prompt by retrieving priority labels and/or dependency relationships from the dependency/priority datastore 701. Additionally or alternatively, the notification processor 530 may also generate the input prompt context by retrieving prior notification messages from the notification datastore 601. In other embodiments, the notification processor 530 may also generate input prompt context by using an input prompt context generator model. The input prompt context generator model may be a ML model trained by inputting a plurality of event messages (in some embodiments, in combination with the priority labels and/or dependency graphs from the dependency/priority datastore 701) which are ground labelled with different input prompt contexts described above, to iteratively generate and optimize coefficients which enable the input prompt context generator model to generate input prompt contexts for different pluralities of event messages based on an input of a plurality of event messages of interest. The input prompt context generator model may be trained on notification server 514 and/or the external model server and locally stored in the storage memory 532. In other embodiments, the notification processor 530 may generate the input prompt context by using alternative or additional ML models or statistical models which analyze the plurality of event messages; in yet other embodiments, the input prompt context for different priorities of event messages may also be defined by humans.

The aggregate event messages process 600 then continues to block 608, which may involve directing the notification processor 530 to input the input prompt including the plurality of event messages (aggregated at block 605) or the input prompt including both the plurality of event messages (aggregated at block 605) and the input prompt context (generated at optional block 606) into an LLM, such as the GPT-language models described above. The LLM is generally configured to generate an aggregation notification message in response to the input prompt. As described above, in some embodiments, the input prompt may include the input prompt context to increase the likelihood of the LLM generating a useable aggregation notification message. As described below, in other embodiments, the LLM may be fine-tuned using the LLM fine-tuning process 650 described below to generate a usable aggregation notification message.

The aggregation notification message may be similar to the “notification message” generated by the various different systems of the service systems 502. In this respect, the aggregation notification message may generally comprise a human-readable message including informational content informing a user of one or more events occurring in the service systems 502 and/or actionable content informing the user of actions to take in response to the one or more events occurring in the service systems 502. As described above and below, in some embodiments, the LLM may be fine-tuned (and/or input prompt engineered) to generate an aggregation notification message that emphasizes a root event and/or high priority event and that describes actions to take in response to the root event and/or the high-priority event. As a non-limiting example, the aggregation notification message may include: “Event X has happened in system X, which has caused event Y and event Z to happen in system Z. You need to perform action A to rectify event X before you can perform actions B and C to rectify events Y and Z”.

The aggregate event messages process 600 then continues to block 610, which may involve directing the notification processor 530 to transmit the aggregation notification message generated by the LLM to a user device (e.g., the merchant user device 512 or the customer user device 516) associated with a user affected or otherwise impacted by the events which cause the plurality of event messages (received at block 602). The notification processor 530 may transmit the aggregation notification message to the user device as any of a variety of electronic communications which can be transmitted between the notification server 514 and a user device. For example, the aggregation notification message may be transmitted as, without limitation, an email sent to an email address associated with the user, a SMS text message sent to a phone number associated with the user, a WiFi or cellular-data text message sent to the email address or the phone number, an application push notification pushed to a mobile application or website application account associated with the user, etc. For example, in embodiments where the input prompt context specifies a message type that a particular user is responsive towards, the notification processor 530 may transmit the aggregation notification message as that message type to the user device associated with that particular user. As a result, instead of the user receiving a multitude of notification messages from different systems in the service systems 502, the user may instead only receive a single aggregation notification message from the notification server 514. The aggregation notification message may include informational content comprising a summary of events which occurred in the service systems 502 and which that the user needs to be aware of and/or actionable content comprising a summary of actions that the user needs to take to respond to the events (or at least one event) which occurred in the service systems 502. The aggregation notification message may also emphasize actions to take in response to root events or high priority events. The aggregation notification message is thus machine-generated text (both content and syntax) that may be based on vast amounts of previously learned text and the aggregated plurality of event messages and may provide informational content and/or actionable content more likely to evoke a required response from a user, thereby enhancing interactions between a user and the system (e.g., the systems of the service systems 502). The aggregation notification message may also provide more versatility when compared to pre-written notification messages, as such aggregation notification messages are generated by the generative language model as the plurality of event messages are received, which may accommodate a large number of different system events, in different orders or combinations.

Further, in some situations, the user may have already received a prior notification message generated from prior event messages associated with prior events occurring in the service systems 502. In some embodiments, when such prior events have a dependency relationship with one or more current events which cause the current plurality of event messages (e.g., received at block 606), the notification processor 530 may transmit the current aggregation notification message as a part of a thread of the prior notification message. For example, the notification processor 530 may transmit the current aggregation message with a same title, or with the same header, as the prior notification message. The notification processor 530 may retrieve prior notification messages from the notification datastore 601 and may retrieve dependency relationships between different events from the dependency/priority datastore 701.

The aggregate event messages process 600 then continues to block 612, which may involve directing the notification processor 530 to store the aggregation notification message generated by the generative language model in the notification datastore 601. The notification processor 530 may store the single aggregation notification message in the notification datastore 601 in association with one or more of: the plurality of event messages received at block 602, the events occurring in the service systems 502 which cause the plurality of event messages, the aggregation trigger determined at block 604, a user identifier identifying the user (e.g., the customer user and/or the merchant user) and/or the user device (e.g., the customer user device 516 and/or the merchant user device 512) that the single notification message was transmitted to, and a time stamp of transmission of the aggregation notification message. The aggregate event messages process 600 then ends.

### LLM Fine-Tuning Process 650

Referring back to FIG. 4, in some embodiments, the notification server 514 may be configured to train or otherwise fine-tune the generative language model used in the aggregate event messages process 600 described above and may execute the LLM fine-tuning process 650. In the embodiment shown, the LLM fine-tuning process 650 comprises machine, processor and/or computer readable instructions stored in the program memory 534 for execution by the notification processor 530; in other embodiments, the LLM fine-tuning process 650 may comprise processor, machine and/or computer readable instructions alternatively stored on other non-transitory computer readable storage medium such as a CD-ROM, a floppy disk, a hard drive, a DVD, a Blu-ray disk or another component associated with the edge server 304; in yet other embodiments, the LLM fine-tuning process 650 and/or parts thereof could alternatively be executed by a device other than the notification processor 530, such as by the external model server for example.

In the embodiment shown, the LLM fine-tuning process 650 include codes which direct the notification processor 530 to adjust or otherwise optimize weights or biases associated with coefficients within the LLM to allow the LLM to better generate a usable aggregation notification message in response to an input prompt (e.g., generated at block 605 and/or block 606 of the aggregate event messages process 600 described above). For example, the LLM fine-tuning process 650 may involve directing the notification processor 530 to generate one or more training sets for training the LLM.

In some embodiments, the training sets generated or formed by notification processor 530 may include a) training input prompts which are associated with (e.g., ground labelled with) b) respective training aggregation notification messages. In other words, the training set may comprise a plurality of training pairs, where each training pair includes a training input prompt and a corresponding notification message. The training input prompts may be based on a simple aggregation of a plurality of event messages or may be based on both the aggregation of the plurality of event messages and input prompt context (e.g., engineered at block 606 of the aggregate event messages process 600). The training notification messages may comprise usable or desirable aggregation notification messages to be generated using the training input prompts. The training pairs may be inputted into the LLM to iteratively generate and/or optimize coefficients (e.g., through the backpropagation described above) which enables the LLM to generate usable aggregation notification messages in response to input prompts. As a more specific non-limiting example, each training pair is a training prompt-completion pair, where the training prompt is an aggregation (e.g., concatenation) of event messages (possibly with additional input prompt context), and the training completion is the corresponding usable or desired notification message. When the training prompt is input into the LLM, the output is used to compute a loss function, e.g., based on a conditional probability of the actual completion outputted being equal to the training completion given the training input prompt, where a lower conditional probability correlates with a higher loss. The loss value output from the loss function is used to update parameters of the LLM through backpropagation to try to reduce or minimize the loss.

In some embodiments, the training set generated or formed by the notification processor 530 may also or instead include a) a plurality of training aggregation notification messages which are associated with (e.g., ground labelled with) b) corresponding rankings for each of the plurality of training aggregation notification messages. In other words, the training set may comprise a plurality of training pairs, where each training pair includes a training aggregation notification message and a corresponding rank. Each training aggregation notification message of the plurality of training aggregation notification messages may be generated by the LLM in response to a same training input prompt including, for example, a same aggregation of a plurality of event messages and/or a same input prompt context. The corresponding rank may indicate a relative usability or desirability of each of the plurality of training aggregation notification messages for that particular training input prompt. The corresponding rank may be assigned in response to user responses and user response rates. For example, a rank of “1” may indicate a highly useable or desirable aggregation notification message for the particular training input prompt (associated with positive user responses, and/or associated with a high number of users (or a high number of a particular type of users) performing the prompted action and/or otherwise associated with high user response rates), whereas a rank of “10” may indicate an undesirable aggregation notification message for that particular training input prompt (associated with negative user responses and/or associated with a low number of users (or a low number of a particular type of users) performing the prompted action and/or otherwise associated with low user response rates). For example, the training pairs may be inputted into the LLM to iteratively generate and/or optimize coefficients which enable the LLM to generate usable aggregation notification messages in response to input prompts, and may enable the LLM to determine which aggregation notification messages are of a higher rank or higher quality. The ability to fine-tune the LLM through user responses and/or user response rates to the aggregation notification message allows an operator of the notification server 514 (or of the service systems 502 and/or the software platform 500) to assess and improve the quality of the aggregation notification messages generated by the LLM and to determine whether any further fine-tuning of the LLM is required. Further, the use of user responses and/or user response rates to the aggregation notification message (e.g., by the user performing or not performing the prompted action(s) in the aggregation notification message) can also reduce a need for the operator to seek active feedback from a user regarding a quality of the aggregation notification messages, as such feedback is implicitly provided by the user's response (or lack thereof) to the aggregation notification message.

The methods above involve fine-tuning training of a generative language model, such as an LLM, to customize the LLM for its specific use described herein. A technical benefit of fine-tuning is that an existing LLM pre-trained on a vast amount of non-specific text (e.g., from the internet) can be obtained, with only additional fine-tuning training performed to optimize/customize the LLM to generate the aggregation notification message described above. This saves significant training resources and may provide better performance than training an LLM from scratch on a smaller training set.

### Alternative Method 750 for Generating a Notification Message Using an LLM

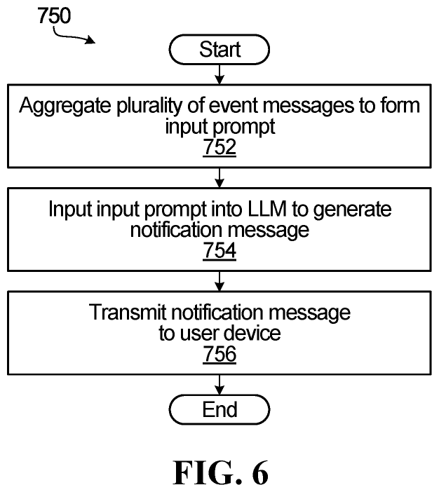

Referring to FIG. 6, a computer-implemented method for using a generative language model, such as the LLMs described above, to generate a notification message based on an input prompt is generally shown at 750. The input prompt may comprise an aggregation of a plurality of event messages received from the different systems (or subsystems) of the service systems 502. In the embodiment shown, the method 750 is performed by the notification processor 530 executing processor, machine and/or computer readable instructions stored in the program memory 534; in other embodiments, the method 750 may comprise processor, machine and/or computer readable instructions alternatively stored on other non-transitory computer readable storage medium; in yet other embodiments, the method 750 and/or parts thereof could alternatively be executed by a device other than the notification processor 530, including for example, by the external model server. Further, although the method 750 in accordance with one embodiment is described with reference to the flowchart illustrated in FIG. 6, other methods of implementing the method 750 may alternatively be used. For example, the order of execution of the blocks may be altered, and/or some of the blocks described may be altered, eliminated, or combined.

At block 752, the notification server 514 aggregates a plurality of event messages to form an input prompt. Aggregating the plurality of event messages may comprise concatenating the plurality of event messages one after the other, possibly with a particular token used to indicate where one message ends and another begins. The plurality of event messages may be associated with at least one event occurring in at least one computer system. The at least one event may impact a user associated with a user device. The at least one computer system may comprise at least one system of the service systems 502. Although the service systems 502 is assumed in the method of FIG. 6, more generally the at least one computer system may be part of a software platform that has no relation to e-commerce, in which case there are not the merchant user device 512 and the customer device 516, but simply user devices.

The plurality of event messages may comprise human-readable messages (e.g., the notification messages described above) generated by at least one system of the service systems 502 for transmission to a user device (e.g., the merchant user device 512 and/or the customer user device 516) which are now instead initially received by the notification server 514. The plurality of event messages may alternatively comprise machine-readable messages (e.g., the error messages described above) generated by at least one system of the service systems 502.

The at least one event may be a plurality of related events. For example, the plurality of related events may be the first event and the at least one related event described above, where the first event may cause or propagate at least one related event within the service systems 502, and where the at least one related event may similarly cause or propagate the first event. Accordingly, the first event and the at least one related event may have a dependency relationship. The plurality of event messages may include at least one event message associated with the first event, and at least one event message associated with the at least one related event. In other embodiments, the plurality of related events may be the root event and at least one dependent event described above, where the root event may cause or propagate at least one dependent event within the service systems 502. Accordingly, the root event and the at least one dependent event may also have a dependency relationship. The plurality of event messages may include at least one event message associated with the root event and at least one event message associated with the at least one dependent event.

The notification server 514 may aggregate the plurality of messages as the input prompt at block 752 in response to an aggregation trigger (e.g., in a manner similar to block 604 of the aggregate event messages process 600 described above).

In some embodiments, the aggregation trigger may comprise a duration of time having elapsed, and may in particular comprise a duration of time having elapsed since any earlier event message of the plurality of event messages and/or a most recent event message of the plurality of event messages. In embodiments where the aggregation trigger comprises the duration of time having elapsed since any earlier message, any additional event messages received during the duration of time may be included in the plurality of event messages to be aggregated to generate the input prompt. Further, in some embodiments, the event message may include a timestamp associated with when the event which cause the earlier event message actually occurred in the service systems 502 and the aggregation trigger may comprise a duration of time having elapsed since the actual event itself.

In some embodiments, the aggregation trigger may be based on at least one of the relative priority between the plurality of event messages or a priority of an earlier event message of the plurality of event messages. For example, in embodiments where the aggregation trigger comprises the duration of time having elapsed since any earlier event message of the plurality of event messages, the earlier event message may correspond to an event message associated with a high priority event, an event message associated with a root event, and/or an event message associated with a high priority system of the service systems 502. The method 750 may be responsive to receipt of such event messages associated with high priority events, root events and/or high priority systems by initiating the duration of time based on such event messages. Additionally or alternatively, the aggregation trigger may be directly triggered by event messages having a particular priority label (e.g., the “high priority” label generated by the dependency/priority generation process 700 as described above).

In some embodiments, the duration of time that the notification server 514 waits from (i) receiving an earlier event message (which might or might not be a most recent event message) to (ii) aggregating the plurality of event messages (including the earlier event message) into an input prompt and inputting that input prompt into the generative language model may be based on an event associated with the earlier event message. The event associated with the earlier event message will be referred to as the earlier event. For example, the duration of time the system waits may be based on an identity of the earlier event. The identity of the earlier event may be indicative of the priority of the earlier event and/or may be indicative of what other events are related to the earlier event. The duration of time that the notification server 514 waits may dynamically vary depending upon the identity of the earlier event. In some embodiments, if the earlier event is identified as a high priority event, then the duration of time that the notification server 514 waits may be reduced compared to if the earlier event is identified as a lower priority event. In some embodiments, if the earlier event is known (e.g., from a dependency graph or due to at least one dependency relationship) to cause a related event that results in another event message, then the duration of time that the notification server 514 waits may be increased to wait for the event message from the related event, so that the related event message can also be part of the input prompt. The duration of time that the notification server 514 waits may be dependent upon the expected time of the related event. In some embodiments, both the priority of the earlier event and whether the earlier event causes subsequent events may be used to determine the duration of time that the notification server 514 waits, e.g., high priority events that do not cause further events may correspond to a short wait time, while lower priority events that cause other events may correspond to a longer wait time. By having the duration of time that the notification server 514 waits be based on the earlier event (e.g., based on the identity of the earlier event), the system can dynamically decrease or increase the amount of time that passes before the plurality of event messages are inputted into the generative language model to generate the notification message. This may allow for the notification server 514 to better balance the desire to promptly send a notification message to the user device while still waiting to collect and aggregate relevant/related event messages in order to provide a single comprehensive notification message.

At block 754, the notification server 514 inputs the input prompt into a generative language model to generate a notification message based on the plurality of event messages.

In some embodiments, the input prompt may further include text representing input prompt context associated with one or more of the plurality of event messages (e.g., in a manner similar to block 606 of the aggregate event messages process 600 described above). The input prompt context may include text indication of one or more of: a relative priority between the plurality of event messages, a message of the plurality of event messages associated with a high priority event, a message of the plurality of event messages associated with a root event, features of a desired notification message, one or more examples of the desired notification message, or any prior notification messages transmitted to the user device.

At block 756, the notification server 514 transmits the notification message to a user device. The notification message may comprise a human-readable message. The notification message may include informational content informing a user of the at least one event occurring in the at least one computer system, and may further identify a priority event or a root event. The notification message may also or instead include actionable content informing the user of actions to take in response to the at least one event.

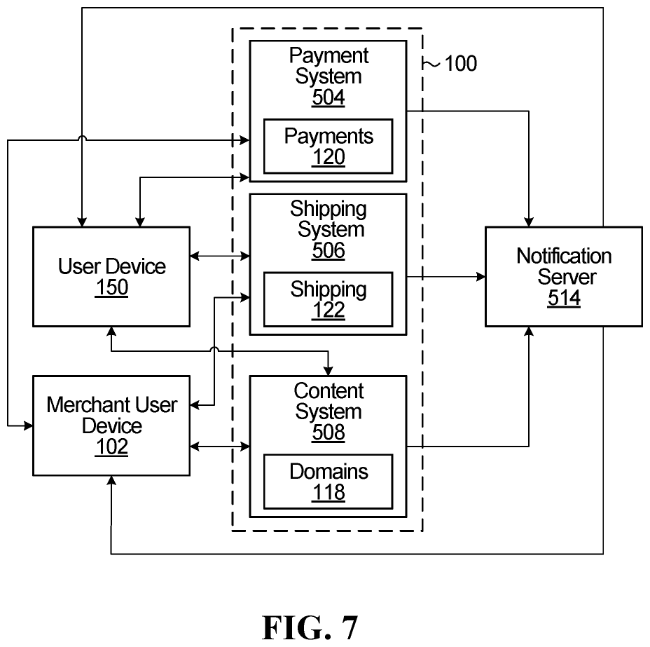

FIG. 7 illustrates an example in which the service systems 502 of FIG. 3 comprise components of a commerce platform, whereby the software platform 500 of FIG. 3 comprises an e-commerce platform 100. The customer user device 516 may include customer device 150 and the merchant user device 512 may include merchant device 102. The payment system 504 may facilitate payment services 120 offered by the e-commerce platform 100, the shipping system 506 may facilitate shipping services 122 offered by the e-commerce platform 100, and the content system 508 may facilitate domain registration services 118 and/or business support services 116 offered by the e-commerce platform 100. The various notification messages generated by the various services of the e-commerce platform 100 may be aggregated by the notification server 514. One example of an e-commerce platform 100 is described below for completeness, it being understood that the methods described herein need not be limited to e-commerce because many platforms outside of e-commerce have multiple computer systems that offer services to users and may generate event messages for users.

Example e-Commerce Platform

Although integration with a commerce platform is not required, in some embodiments, the methods disclosed herein may be performed on or in association with a commerce platform such as an e-commerce platform. Therefore, an example of a commerce platform will be described.

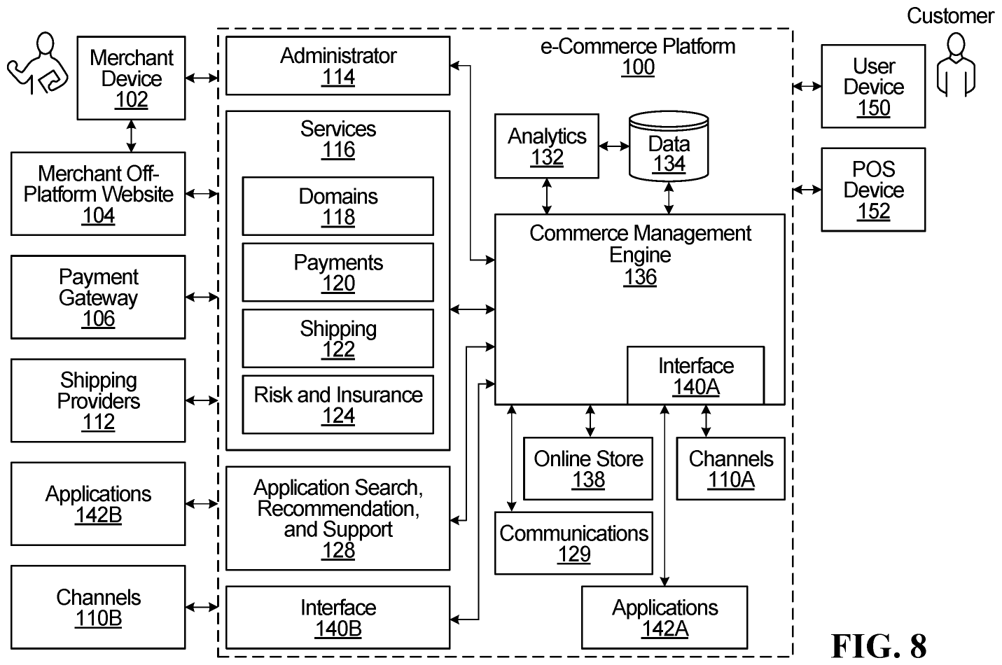

FIG. 8 illustrates an example e-commerce platform 100, according to one embodiment. The e-commerce platform 100 may be used to provide merchant products and services to customers. While the disclosure contemplates using the apparatus, system, and process to purchase products and services, for simplicity the description herein will refer to products. All references to products throughout this disclosure should also be understood to be references to products and/or services, including, for example, physical products, digital content (e.g., music, videos, games), software, tickets, subscriptions, services to be provided, and the like.

While the disclosure throughout contemplates that a ‘merchant’ and a ‘customer’ may be more than individuals, for simplicity the description herein may generally refer to merchants and customers as such. All references to merchants and customers throughout this disclosure should also be understood to be references to groups of individuals, companies, corporations, computing entities, and the like, and may represent for-profit or not-for-profit exchange of products. Further, while the disclosure throughout refers to ‘merchants’ and ‘customers’, and describes their roles as such, the e-commerce platform 100 should be understood to more generally support users in an e-commerce environment, and all references to merchants and customers throughout this disclosure should also be understood to be references to users, such as where a user is a merchant-user (e.g., a seller, retailer, wholesaler, or provider of products), a customer-user (e.g., a buyer, purchase agent, consumer, or user of products), a prospective user (e.g., a user browsing and not yet committed to a purchase, a user evaluating the e-commerce platform 100 for potential use in marketing and selling products, and the like), a service provider user (e.g., a shipping provider 112, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like. Furthermore, it may be recognized that while a given user may act in a given role (e.g., as a merchant) and their associated device may be referred to accordingly (e.g., as a merchant device) in one context, that same individual may act in a different role in another context (e.g., as a customer) and that same or another associated device may be referred to accordingly (e.g., as a customer device). For example, an individual may be a merchant for one type of product (e.g., shoes), and a customer/consumer of other types of products (e.g., groceries). In another example, an individual may be both a consumer and a merchant of the same type of product. In a particular example, a merchant that trades in a particular category of goods may act as a customer for that same category of goods when they order from a wholesaler (the wholesaler acting as merchant).

The e-commerce platform 100 provides merchants with online services/facilities to manage their business. The facilities described herein are shown implemented as part of the platform 100 but could also be configured separately from the platform 100, in whole or in part, as stand-alone services. Furthermore, such facilities may, in some embodiments, may, additionally or alternatively, be provided by one or more providers/entities.

In the example of FIG. 8, the facilities are deployed through a machine, service or engine that executes computer software, modules, program codes, and/or instructions on one or more processors which, as noted above, may be part of or external to the platform 100. Merchants may utilize the e-commerce platform 100 for enabling or managing commerce with customers, such as by implementing an e-commerce experience with customers through an online store 138, applications 142A-B, channels 110A-B, and/or through point of sale (POS) devices 152 in physical locations (e.g., a physical storefront or other location such as through a kiosk, terminal, reader, printer, 3D printer, and the like). A merchant may utilize the e-commerce platform 100 as a sole commerce presence with customers, or in conjunction with other merchant commerce facilities, such as through a physical store (e.g., ‘brick-and-mortar’ retail stores), a merchant off-platform website 104 (e.g., a commerce Internet website or other internet or web property or asset supported by or on behalf of the merchant separately from the e-commerce platform 100), an application 142B, and the like. However, even these ‘other’ merchant commerce facilities may be incorporated into or communicate with the e-commerce platform 100, such as where POS devices 152 in a physical store of a merchant are linked into the e-commerce platform 100, where a merchant off-platform website 104 is tied into the e-commerce platform 100, such as, for example, through ‘buy buttons’ that link content from the merchant off platform website 104 to the online store 138, or the like.

The online store 138 may represent a multi-tenant facility comprising a plurality of virtual storefronts. In embodiments, merchants may configure and/or manage one or more storefronts in the online store 138, such as, for example, through a merchant device 102 (e.g., computer, laptop computer, mobile computing device, and the like), and offer products to customers through a number of different channels 110A-B (e.g., an online store 138; an application 142A-B; a physical storefront through a POS device 152; an electronic marketplace, such, for example, through an electronic buy button integrated into a website or social media channel such as on a social network, social media page, social media messaging system; and/or the like). A merchant may sell across channels 110A-B and then manage their sales through the e-commerce platform 100, where channels 110A may be provided as a facility or service internal or external to the e-commerce platform 100. A merchant may, additionally or alternatively, sell in their physical retail store, at pop ups, through wholesale, over the phone, and the like, and then manage their sales through the e-commerce platform 100. A merchant may employ all or any combination of these operational modalities. Notably, it may be that by employing a variety of and/or a particular combination of modalities, a merchant may improve the probability and/or volume of sales. Throughout this disclosure the terms online store 138 and storefront may be used synonymously to refer to a merchant's online e-commerce service offering through the e-commerce platform 100, where an online store 138 may refer either to a collection of storefronts supported by the e-commerce platform 100 (e.g., for one or a plurality of merchants) or to an individual merchant's storefront (e.g., a merchant's online store).

In some embodiments, a customer may interact with the platform 100 through a customer device 150 (e.g., computer, laptop computer, mobile computing device, or the like), a POS device 152 (e.g., retail device, kiosk, automated (self-service) checkout system, or the like), and/or any other commerce interface device known in the art. The e-commerce platform 100 may enable merchants to reach customers through the online store 138, through applications 142A-B, through POS devices 152 in physical locations (e.g., a merchant's storefront or elsewhere), to communicate with customers via electronic communication facility 129, and/or the like so as to provide a system for reaching customers and facilitating merchant services for the real or virtual pathways available for reaching and interacting with customers.

In some embodiments, and as described further herein, the e-commerce platform 100 may be implemented through a processing facility. Such a processing facility may include a processor and a memory. The processor may be a hardware processor. The memory may be and/or may include a non-transitory computer-readable medium. The memory may be and/or may include random access memory (RAM) and/or persisted storage (e.g., magnetic storage). The processing facility may store a set of instructions (e.g., in the memory) that, when executed, cause the e-commerce platform 100 to perform the e-commerce and support functions as described herein. The processing facility may be or may be a part of one or more of a server, client, network infrastructure, mobile computing platform, cloud computing platform, stationary computing platform, and/or some other computing platform, and may provide electronic connectivity and communications between and amongst the components of the e-commerce platform 100, merchant devices 102, payment gateways 106, applications 142A-B, channels 110A-B, shipping providers 112, customer devices 150, point of sale devices 152, etc., In some implementations, the processing facility may be or may include one or more such computing devices acting in concert. For example, it may be that a plurality of co-operating computing devices serves as/to provide the processing facility. The e-commerce platform 100 may be implemented as or using one or more of a cloud computing service, software as a service (SaaS), infrastructure as a service (IaaS), platform as a service (PaaS), desktop as a service (DaaS), managed software as a service (MSaaS), mobile backend as a service (MBaaS), information technology management as a service (ITMaaS), and/or the like. For example, it may be that the underlying software implementing the facilities described herein (e.g., the online store 138) is provided as a service, and is centrally hosted (e.g., and then accessed by users via a web browser or other application, and/or through customer devices 150, POS devices 152, and/or the like). In some embodiments, elements of the e-commerce platform 100 may be implemented to operate and/or integrate with various other platforms and operating systems.

In some embodiments, the facilities of the e-commerce platform 100 (e.g., the online store 138) may serve content to a customer device 150 (using data 134) such as, for example, through a network connected to the e-commerce platform 100. For example, the online store 138 may serve or send content in response to requests for data 134 from the customer device 150, where a browser (or other application) connects to the online store 138 through a network using a network communication protocol (e.g., an internet protocol). The content may be written in machine readable language and may include Hypertext Markup Language (HTML), template language, JavaScript, and the like, and/or any combination thereof.

In some embodiments, online store 138 may be or may include service instances that serve content to customer devices and allow customers to browse and purchase the various products available (e.g., add them to a cart, purchase through a buy-button, and the like). Merchants may also customize the look and feel of their website through a theme system, such as, for example, a theme system where merchants can select and change the look and feel of their online store 138 by changing their theme while having the same underlying product and business data shown within the online store's product information. It may be that themes can be further customized through a theme editor, a design interface that enables users to customize their website's design with flexibility. Additionally or alternatively, it may be that themes can, additionally or alternatively, be customized using theme-specific settings such as, for example, settings as may change aspects of a given theme, such as, for example, specific colors, fonts, and pre-built layout schemes. In some implementations, the online store may implement a content management system for website content. Merchants may employ such a content management system in authoring blog posts or static pages and publish them to their online store 138, such as through blogs, articles, landing pages, and the like, as well as configure navigation menus. Merchants may upload images (e.g., for products), video, content, data, and the like to the e-commerce platform 100, such as for storage by the system (e.g., as data 134). In some embodiments, the e-commerce platform 100 may provide functions for manipulating such images and content such as, for example, functions for resizing images, associating an image with a product, adding and associating text with an image, adding an image for a new product variant, protecting images, and the like.

As described herein, the e-commerce platform 100 may provide merchants with sales and marketing services for products through a number of different channels 110A-B, including, for example, the online store 138, applications 142A-B, as well as through physical POS devices 152 as described herein. The e-commerce platform 100 may, additionally or alternatively, include business support services 116, an administrator 114, a warehouse management system, and the like associated with running an on-line business, such as, for example, one or more of providing a domain registration service 118 associated with their online store, payment services 120 for facilitating transactions with a customer, shipping services 122 for providing customer shipping options for purchased products, fulfillment services for managing inventory, risk and insurance services 124 associated with product protection and liability, merchant billing, and the like. Services 116 may be provided via the e-commerce platform 100 or in association with external facilities, such as through a payment gateway 106 for payment processing, shipping providers 112 for expediting the shipment of products, and the like.

In some embodiments, the e-commerce platform 100 may be configured with shipping services 122 (e.g., through an e-commerce platform shipping facility or through a third-party shipping carrier), to provide various shipping-related information to merchants and/or their customers such as, for example, shipping label or rate information, real-time delivery updates, tracking, and/or the like.

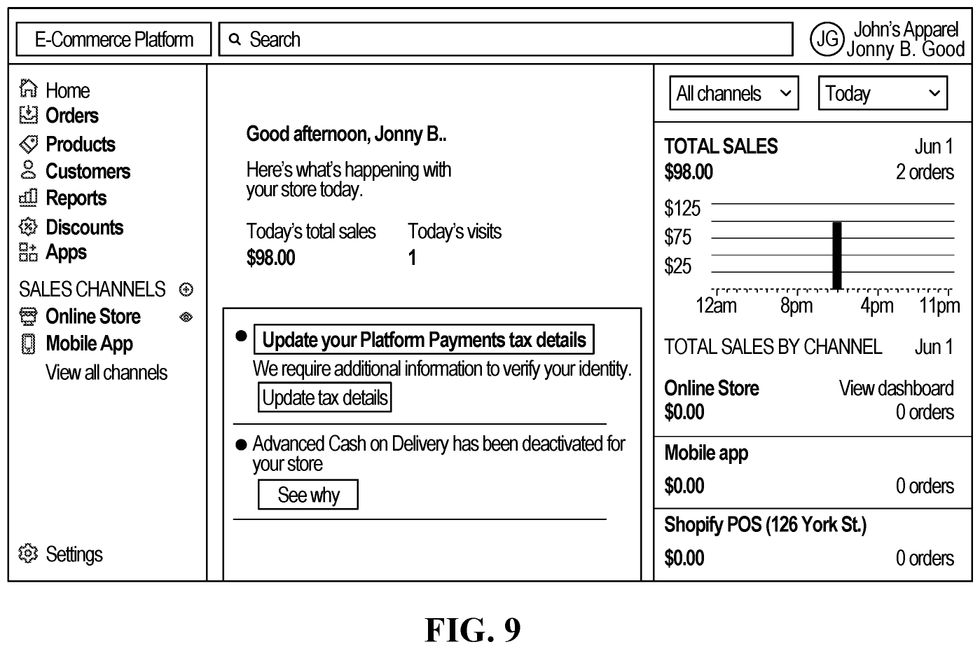

FIG. 9 depicts a non-limiting embodiment for a home page of an administrator 114. The administrator 114 may be referred to as an administrative console and/or an administrator console. The administrator 114 may show information about daily tasks, a store's recent activity, and the next steps a merchant can take to build their business. In some embodiments, a merchant may log in to the administrator 114 via a merchant device 102 (e.g., a desktop computer or mobile device), and manage aspects of their online store 138, such as, for example, viewing the online store's 138 recent visit or order activity, updating the online store's 138 catalog, managing orders, and/or the like. In some embodiments, the merchant may be able to access the different sections of the administrator 114 by using a sidebar, such as the one shown on FIG. 9. Sections of the administrator 114 may include various interfaces for accessing and managing core aspects of a merchant's business, including orders, products, customers, available reports and discounts. The administrator 114 may, additionally or alternatively, include interfaces for managing sales channels for a store including the online store 138, mobile application(s) made available to customers for accessing the store (Mobile App), POS devices, and/or a buy button. The administrator 114 may, additionally or alternatively, include interfaces for managing applications (apps) installed on the merchant's account; and settings applied to a merchant's online store 138 and account. A merchant may use a search bar to find products, pages, or other information in their store.

More detailed information about commerce and visitors to a merchant's online store 138 may be viewed through reports or metrics. Reports may include, for example, acquisition reports, behavior reports, customer reports, finance reports, marketing reports, sales reports, product reports, and custom reports. The merchant may be able to view sales data for different channels 110A-B from different periods of time (e.g., days, weeks, months, and the like), such as by using drop-down menus. An overview dashboard may also be provided for a merchant who wants a more detailed view of the store's sales and engagement data. An activity feed in the home metrics section may be provided to illustrate an overview of the activity on the merchant's account. For example, by clicking on a ‘view all recent activity’ dashboard button, the merchant may be able to see a longer feed of recent activity on their account. A home page may show notifications about the merchant's online store 138, such as based on account status, growth, recent customer activity, order updates, and the like. Notifications may be provided to assist a merchant with navigating through workflows configured for the online store 138, such as, for example, a payment workflow, an order fulfillment workflow, an order archiving workflow, a return workflow, and the like.

The e-commerce platform 100 may provide for a communications facility 129 and associated merchant interface for providing electronic communications and marketing, such as utilizing an electronic messaging facility for collecting and analyzing communication interactions between merchants, customers, merchant devices 102, customer devices 150, POS devices 152, and the like, to aggregate and analyze the communications, such as for increasing sale conversions, and the like. For instance, a customer may have a question related to a product, which may produce a dialog between the customer and the merchant (or an automated processor-based agent/chatbot representing the merchant), where the communications facility 129 is configured to provide automated responses to customer requests and/or provide recommendations to the merchant on how to respond such as, for example, to improve the probability of a sale.

The e-commerce platform 100 may provide a financial facility 120 for secure financial transactions with customers, such as through a secure card server environment. The e-commerce platform 100 may store credit card information, such as in payment card industry data (PCI) environments (e.g., a card server), to reconcile financials, bill merchants, perform automated clearing house (ACH) transfers between the e-commerce platform 100 and a merchant's bank account, and the like. The financial facility 120 may also provide merchants and buyers with financial support, such as through the lending of capital (e.g., lending funds, cash advances, and the like) and provision of insurance. In some embodiments, online store 138 may support a number of independently administered storefronts and process a large volume of transactional data on a daily basis for a variety of products and services. Transactional data may include any customer information indicative of a customer, a customer account or transactions carried out by a customer such as, for example, contact information, billing information, shipping information, returns/refund information, discount/offer information, payment information, or online store events or information such as page views, product search information (search keywords, click-through events), product reviews, abandoned carts, and/or other transactional information associated with business through the e-commerce platform 100. In some embodiments, the e-commerce platform 100 may store this data in a data facility 134. Referring again to FIG. 8, in some embodiments the e-commerce platform 100 may include a commerce management engine 136 such as may be configured to perform various workflows for task automation or content management related to products, inventory, customers, orders, suppliers, reports, financials, risk and fraud, and the like. In some embodiments, additional functionality may, additionally or alternatively, be provided through applications 142A-B to enable greater flexibility and customization required for accommodating an ever-growing variety of online stores, POS devices, products, and/or services. Applications 142A may be components of the e-commerce platform 100 whereas applications 142B may be provided or hosted as a third-party service external to e-commerce platform 100. The commerce management engine 136 may accommodate store-specific workflows and in some embodiments, may incorporate the administrator 114 and/or the online store 138.

Implementing functions as applications 142A-B may enable the commerce management engine 136 to remain responsive and reduce or avoid service degradation or more serious infrastructure failures, and the like.

Although isolating online store data can be important to maintaining data privacy between online stores 138 and merchants, there may be reasons for collecting and using cross-store data, such as, for example, with an order risk assessment system or a platform payment facility, both of which require information from multiple online stores 138 to perform well. In some embodiments, it may be preferable to move these components out of the commerce management engine 136 and into their own infrastructure within the e-commerce platform 100.

Platform payment facility 120 is an example of a component that utilizes data from the commerce management engine 136 but is implemented as a separate component or service. The platform payment facility 120 may allow customers interacting with online stores 138 to have their payment information stored safely by the commerce management engine 136 such that they only have to enter it once. When a customer visits a different online store 138, even if they have never been there before, the platform payment facility 120 may recall their information to enable a more rapid and/or potentially less-error prone (e.g., through avoidance of possible mis-keying of their information if they needed to instead re-enter it) checkout. This may provide a cross-platform network effect, where the e-commerce platform 100 becomes more useful to its merchants and buyers as more merchants and buyers join, such as because there are more customers who checkout more often because of the ease of use with respect to customer purchases. To maximize the effect of this network, payment information for a given customer may be retrievable and made available globally across multiple online stores 138.

For functions that are not included within the commerce management engine 136, applications 142A-B provide a way to add features to the e-commerce platform 100 or individual online stores 138. For example, applications 142A-B may be able to access and modify data on a merchant's online store 138, perform tasks through the administrator 114, implement new flows for a merchant through a user interface (e.g., that is surfaced through extensions/API), and the like. Merchants may be enabled to discover and install applications 142A-B through application search, recommendations, and support 128. In some embodiments, the commerce management engine 136, applications 142A-B, and the administrator 114 may be developed to work together. For instance, application extension points may be built inside the commerce management engine 136, accessed by applications 142A and 142B through the interfaces 140B and 140A to deliver additional functionality, and surfaced to the merchant in the user interface of the administrator 114.

In some embodiments, applications 142A-B may deliver functionality to a merchant through the interface 140A-B, such as where an application 142A-B is able to surface transaction data to a merchant (e.g., App: “Engine, surface my app data in the Mobile App or administrator 114”), and/or where the commerce management engine 136 is able to ask the application to perform work on demand (Engine: “App, give me a local tax calculation for this checkout”).

Applications 142A-B may be connected to the commerce management engine 136 through an interface 140A-B (e.g., through REST (REpresentational State Transfer) and/or GraphQL APIs) to expose the functionality and/or data available through and within the commerce management engine 136 to the functionality of applications. For instance, the e-commerce platform 100 may provide API interfaces 140A-B to applications 142A-B which may connect to products and services external to the platform 100. The flexibility offered through use of applications and APIs (e.g., as offered for application development) enable the e-commerce platform 100 to better accommodate new and unique needs of merchants or to address specific use cases without requiring constant change to the commerce management engine 136. For instance, shipping services 122 may be integrated with the commerce management engine 136 through a shipping or carrier service API, thus enabling the e-commerce platform 100 to provide shipping service functionality without directly impacting code running in the commerce management engine 136.

Depending on the implementation, applications 142A-B may utilize APIs to pull data on demand (e.g., customer creation events, product change events, or order cancelation events, etc.) or have the data pushed when updates occur. A subscription model may be used to provide applications 142A-B with events as they occur or to provide updates with respect to a changed state of the commerce management engine 136. In some embodiments, when a change related to an update event subscription occurs, the commerce management engine 136 may post a request, such as to a predefined callback URL. The body of this request may contain a new state of the object and a description of the action or event. Update event subscriptions may be created manually, in the administrator facility 114, or automatically (e.g., via the API 140A-B). In some embodiments, update events may be queued and processed asynchronously from a state change that triggered them, which may produce an update event notification that is not distributed in real-time or near-real time.

In some embodiments, the e-commerce platform 100 may provide one or more of application search, recommendation and support 128. Application search, recommendation and support 128 may include developer products and tools to aid in the development of applications, an application dashboard (e.g., to provide developers with a development interface, to administrators for management of applications, to merchants for customization of applications, and the like), facilities for installing and providing permissions with respect to providing access to an application 142A-B (e.g., for public access, such as where criteria must be met before being installed, or for private use by a merchant), application searching to make it easy for a merchant to search for applications 142A-B that satisfy a need for their online store 138, application recommendations to provide merchants with suggestions on how they can improve the user experience through their online store 138, and the like. In some embodiments, applications 142A-B may be assigned an application identifier (ID), such as for linking to an application (e.g., through an API), searching for an application, making application recommendations, and the like.

Applications 142A-B may be grouped roughly into three categories: customer-facing applications, merchant-facing applications, integration applications, and the like. Customer-facing applications 142A-B may include an online store 138 or channels 110A-B that are places where merchants can list products and have them purchased (e.g., the online store, applications for flash sales (e.g., merchant products or from opportunistic sales opportunities from third-party sources), a mobile store application, a social media channel, an application for providing wholesale purchasing, and the like). Merchant-facing applications 142A-B may include applications that allow the merchant to administer their online store 138 (e.g., through applications related to the web or website or to mobile devices), run their business (e.g., through applications related to POS devices), to grow their business (e.g., through applications related to shipping (e.g., drop shipping), use of automated agents, use of process flow development and improvements), and the like. Integration applications may include applications that provide useful integrations that participate in the running of a business, such as shipping providers 112 and payment gateways 106.

As such, the e-commerce platform 100 can be configured to provide an online shopping experience through a flexible system architecture that enables merchants to connect with customers in a flexible and transparent manner. A typical customer experience may be better understood through an embodiment example purchase workflow, where the customer browses the merchant's products on a channel 110A-B, adds what they intend to buy to their cart, proceeds to checkout, and pays for the content of their cart resulting in the creation of an order for the merchant. The merchant may then review and fulfill (or cancel) the order. The product is then delivered to the customer. If the customer is not satisfied, they might return the products to the merchant.

In an example embodiment, a customer may browse a merchant's products through a number of different channels 110A-B such as, for example, the merchant's online store 138, a physical storefront through a POS device 152; an electronic marketplace, through an electronic buy button integrated into a website or a social media channel). In some cases, channels 110A-B may be modeled as applications 142A-B. A merchandising component in the commerce management engine 136 may be configured for creating, and managing product listings (using product data objects or models for example) to allow merchants to describe what they want to sell and where they sell it. The association between a product listing and a channel may be modeled as a product publication and accessed by channel applications, such as via a product listing API. A product may have many attributes and/or characteristics, like size and color, and many variants that expand the available options into specific combinations of all the attributes, like a variant that is size extra small and green, or a variant that is size large and blue. Products may have at least one variant (e.g., a “default variant”) created for a product without any options. To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Product listings may include 2D images, 3D images or models, which may be viewed through a virtual or augmented reality interface, and the like.

In some embodiments, a shopping cart object is used to store or keep track of the products that the customer intends to buy. The shopping cart object may be channel specific and can be composed of multiple cart line items, where each cart line item tracks the quantity for a particular product variant. Since adding a product to a cart does not imply any commitment from the customer or the merchant, and the expected lifespan of a cart may be in the order of minutes (not days), cart objects/data representing a cart may be persisted to an ephemeral datastore.

The customer then proceeds to checkout. A checkout object or page generated by the commerce management engine 136 may be configured to receive customer information to complete the order such as the customer's contact information, billing information and/or shipping details. If the customer inputs their contact information but does not proceed to payment, the e-commerce platform 100 may (e.g., via an abandoned checkout component) transmit a message to the customer device 150 to encourage the customer to complete the checkout. For those reasons, checkout objects can have much longer lifespans than cart objects (hours or even days) and may therefore be persisted. Customers then pay for the content of their cart resulting in the creation of an order for the merchant. In some embodiments, the commerce management engine 136 may be configured to communicate with various payment gateways and services 106 (e.g., online payment systems, mobile payment systems, digital wallets, credit card gateways) via a payment processing component. The actual interactions with the payment gateways 106 may be provided through a card server environment. At the end of the checkout process, an order is created. An order is a contract of sale between the merchant and the customer where the merchant agrees to provide the goods and services listed on the order (e.g., order line items, shipping line items, and the like) and the customer agrees to provide payment (including taxes). Once an order is created, an order confirmation notification may be sent to the customer and an order placed notification sent to the merchant via a notification component. Inventory may be reserved when a payment processing job starts to avoid over selling (e.g., merchants may control this behavior using an inventory policy or configuration for each variant). Inventory reservation may have a short time span (minutes) and may need to be fast and scalable to support flash sales or “drops”, which are events during which a discount, promotion or limited inventory of a product may be offered for sale for buyers in a particular location and/or for a particular (usually short) time. The reservation is released if the payment fails. When the payment succeeds, and an order is created, the reservation is converted into a permanent (long-term) inventory commitment allocated to a specific location. An inventory component of the commerce management engine 136 may record where variants are stocked, and may track quantities for variants that have inventory tracking enabled. It may decouple product variants (a customer-facing concept representing the template of a product listing) from inventory items (a merchant-facing concept that represents an item whose quantity and location is managed). An inventory level component may keep track of quantities that are available for sale, committed to an order or incoming from an inventory transfer component (e.g., from a vendor).

The merchant may then review and fulfill (or cancel) the order. A review component of the commerce management engine 136 may implement a business process merchant's use to ensure orders are suitable for fulfillment before actually fulfilling them. Orders may be fraudulent, require verification (e.g., ID checking), have a payment method which requires the merchant to wait to make sure they will receive their funds, and the like. Risks and recommendations may be persisted in an order risk model. Order risks may be generated from a fraud detection tool, submitted by a third party through an order risk API, and the like. Before proceeding to fulfillment, the merchant may need to capture the payment information (e.g., credit card information) or wait to receive it (e.g., via a bank transfer, check, and the like) before it marks the order as paid. The merchant may now prepare the products for delivery. In some embodiments, this business process may be implemented by a fulfillment component of the commerce management engine 136. The fulfillment component may group the line items of the order into a logical fulfillment unit of work based on an inventory location and fulfillment service. The merchant may review, adjust the unit of work, and trigger the relevant fulfillment services, such as through a manual fulfillment service (e.g., at merchant managed locations) used when the merchant picks and packs the products in a box, purchase a shipping label and input its tracking number, or just mark the item as fulfilled. Alternatively, an API fulfillment service may trigger a third-party application or service to create a fulfillment record for a third-party fulfillment service. Other possibilities exist for fulfilling an order. If the customer is not satisfied, they may be able to return the product(s) to the merchant. The business process merchants may go through to “un-sell” an item may be implemented by a return component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees or goods that weren't returned and remain in the customer's hands); and the like. A return may represent a change to the contract of sale (e.g., the order), and where the e-commerce platform 100 may make the merchant aware of compliance issues with respect to legal obligations (e.g., with respect to taxes). In some embodiments, the e-commerce platform 100 may enable merchants to keep track of changes to the contract of sales over time, such as implemented through a sales model component (e.g., an append-only date based ledger that records sale related events that happened to an item).

### CONCLUSION

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

Although the present invention has been described with reference to specific features and embodiments thereof, various modifications and combinations may be made thereto without departing from the invention. The description and drawings are, accordingly, to be regarded simply as an illustration of some embodiments of the invention as defined by the appended claims, and are contemplated to cover any and all modifications, variations, combinations or equivalents that fall within the scope of the present invention. Therefore, although the present invention and its advantages have been described in detail, various changes, substitutions, and alterations may be made herein without departing from the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Moreover, any module, component, or device exemplified herein that executes instructions may include or otherwise have access to a non-transitory computer/processor-readable storage medium or media for storage of information, such as computer/processor-readable instructions, data structures, program modules, and/or other data. A non-exhaustive list of examples of non-transitory computer/processor-readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Any application or module herein described may be implemented using computer/processor readable/executable instructions that may be stored or otherwise held by such non-transitory computer/processor-readable storage media.

Memory, as used herein, may refer to memory that is persistent (e.g., read-only-memory (ROM) or a disk), or memory that is volatile (e.g., random access memory (RAM)). The memory may be distributed, e.g., a same memory may be distributed over one or more servers or locations.

1. A computer-implemented method comprising:
aggregating a plurality of event messages to form an input prompt, the plurality of event messages associated with at least one event occurring in at least one computer system;
inputting the input prompt into a generative language model to generate a notification message based on the plurality of event messages; and
transmitting the notification message to a user device.

2. The computer-implemented method of claim 1, wherein the at least one event comprises a plurality of related events.

3. The computer-implemented method of claim 2, wherein the plurality of related events comprises a root event and a dependent event having a dependency relationship with the root event, and wherein the plurality of event messages comprises an event message associated with the root event and an event message associated with the dependent event.

4. The computer-implemented method of claim 1, further comprising:
aggregating the plurality of event messages as the input prompt in response to an aggregation trigger.

5. The computer-implemented method of claim 4, wherein the aggregation trigger comprises a duration of time having elapsed.

6. The computer-implemented method of claim 4, wherein the aggregation trigger comprises a duration of time having elapsed since an earlier event message of the plurality of event messages.

7. The computer-implemented method of claim 6, wherein the duration of time is based on an event associated with the earlier event message.

8. The computer-implemented method of claim 6, further comprising:
receiving a further event message after the earlier event message during the duration of time; and
adding the further event message to the input prompt.

9. The computer-implemented method of claim 4, wherein the aggregation trigger is based on at least one of a relative priority between the plurality of event messages or a priority of an earlier event message of the plurality of event messages.

10. The computer-implemented method of claim 1, wherein the generative language model comprises a pre-trained generative language model that was fine-tuned by:
creating a training set based on at least training input prompts and training notification messages; and
fine-tune training the pre-trained generative language model using the training set.

11. The computer-implemented method of claim 10, wherein creating the training set comprises:
associating a training input prompt with a training notification message as a training pair, the training input prompt comprising an aggregation of training event messages; and
generating a plurality of the training pairs, wherein the plurality of the training pairs form the training set.

12. The computer-implemented method of claim 10, wherein creating the training set comprises:
generating a training plurality of notification messages based on a particular training input prompt;
associating each of the training plurality of notification messages with a corresponding rank as a training pair; and
creating a plurality of the training pairs, wherein the plurality of the training pairs form the training set.

13. The computer-implemented method of claim 1, wherein the input prompt further includes text representing input prompt context associated with one or more of the plurality of event messages, wherein the input prompt context comprises an indication of at least one of: a relative priority between the plurality of event messages, an event message associated with a high priority event, an event message associated with a root event, features of a desired notification message, one or more examples of the desired notification message, or any prior notification messages transmitted to the user device.

14. The computer-implemented method of claim 1, wherein the notification message includes text representing at least one action to respond to the at least one event.

15. The computer-implemented method of claim 1, wherein the notification message includes text identifying at least one of a priority event of the at least one event or a root event of the at least one event.

16. A system comprising:
at least one processor; and
a non-transitory computer-readable storage medium storing instructions which, when executed by the at least one processor, cause the at least one processor to:
aggregate a plurality of event messages to form an input prompt, the plurality of event messages associated with at least one event occurring in at least one computer system;
input the input prompt into a generative language model to generate a notification message based on the plurality of event messages; and
transmit the notification message to a user device.

17. The system of claim 16, wherein the non-transitory computer-readable storage medium further stores instructions that, when executed, cause the at least one processor to:
aggregate the plurality of event messages as the input prompt in response to an aggregation trigger.

18. The system of claim 16, wherein the generative language model comprises a pre-trained generative language model and wherein the non-transitory computer-readable storage medium further stores instructions that, when executed, cause the at least one processor to:
create a training set based on at least training input prompts and training notification messages; and
fine-tune train the pre-trained generative language model using the training set.

19. The system of claim 16, wherein the input prompt further includes text representing input prompt context associated with one or more of the plurality of event messages, wherein the input prompt context comprises an indication of at least one of: a relative priority between the plurality of event messages, an event message associated with a high priority event, an event message associated with a root event, features of a desired notification message, one or more examples of the desired notification message, or any prior notification messages transmitted to the user device.

20. The system of claim 16, wherein the notification message includes text representing at least one action to respond to the at least one event.

21. A non-transitory computer-readable storage medium having stored thereon computer-executable instruction that, when executed, cause at least one processor to perform operations comprising:
aggregating a plurality of event messages to form an input prompt, the plurality of event messages associated with at least one event occurring in at least one computer system;
inputting the input prompt into a generative language model to generate a notification message based on the plurality of event messages; and
transmitting the notification message to a user device.
